(19) United States
(12) Patent Application Publication
(10) Pub. No.: US 2026/0126659 A1
(43) Pub. Date: May 7, 2026

(54) OPTICAL MEMBER AND AR GLASSES HAVING OPTICAL MEMBER

(71) Applicant: FUJIFILM Corporation, Tokyo (JP)

(72) Inventors: Fumitake MITOBE, Minamiashigara-shi (JP); Naoki KOITO, Minamiashigara-shi (JP)

(73) Assignee: FUJIFILM Corporation, Tokyo (JP)

(21) Appl. No.: 19/439,472

(22) Filed: Jan. 5, 2026

Related U.S. Application Data
(63) Continuation of application No. PCT/JP2024/021039, filed on Jun. 10, 2024.

(30) Foreign Application Priority Data
Jul. 19, 2023 (JP) 2023-117576

(51) Int. Cl. G02B 27/01; G02B 5/18; G02B 5/30

(52) U.S. Cl. CPC G02B 27/0172; G02B 5/1828; G02B 5/3016; G02B 5/3083; G02B 2027/0178

(57) ABSTRACT

An optical member suitable for use in a head-mounted display that permits visual recognition of a background is provided. The optical member includes an optical film having a polarization control layer and an optical absorption anisotropic layer, and a light guide plate disposed on a side of the optical film on which the polarization control layer is provided. The light guide plate includes a diffraction element having a diffraction efficiency that varies with polarization direction. An angle between a transmittance central axis of the optical absorption anisotropic layer and a normal direction of the optical absorption anisotropic layer is from 0 degrees to 45 degrees. The polarization control layer is a quarter-wave film, and, in a use configuration, an angle between a slow axis of the quarter-wave film and a horizontal direction is from 0 degrees to 20 degrees.

### CROSS-REFERENCE TO RELATED APPLICATIONS

This application is a Continuation of PCT International Application No. PCT/JP2024/021039 filed on Jun. 10, 2024, which claims priority under 35 U.S.C. § 119(a) to Japanese Patent Application No. 2023-117576 filed on Jul. 19, 2023. The above applications are hereby expressly incorporated by reference, in their entirety, into the present application.

### BACKGROUND OF THE INVENTION

### 1. Field of the Invention

The present invention relates to an optical member and AR glasses having the optical member.

### 2. Description of the Related Art

In recent years, a head-mounted display such as augmented reality (AR) glasses that superimpose and project a video on a background has appeared.

The AR glasses are configured to include, for example, an image display element, a light guide plate, and a diffraction element, in which video light emitted from the image display element is diffracted by the diffraction element, is incident into the light guide plate, and is guided by the light guide plate such that the guided video light is diffracted by the diffraction element to display the video toward a viewer. Since the light guide plate is transparent, the AR glasses can project the video to superimpose the video on the background.

In such AR glasses, external light incident from a specific oblique direction is diffracted toward a viewer while being color-separated by the diffraction element, and the color-separated external light is visually recognized by the viewer, which causes a problem that it is difficult to visually recognize an image displayed by the AR glasses, a view outside, or the like.

An incidence angle (incidence angle oblique to a main surface of the diffraction element) at which external light is recognized changes depending on a pitch of the diffraction element. However, there is particularly a problem in that external light incident at 40° to 80° with respect to the normal line of the diffraction element is recognized.

On the other hand, in some AR glasses, by reducing a transmittance of external light using a so-called neutral density filter (ND filter), a problem of visibility caused by incidence of external light is suppressed.

### SUMMARY OF THE INVENTION

However, in a head-mounted display such as AR glasses in which a background can be visually recognized, in order to suppress the visibility problem caused by incidence of external light, it is necessary to reduce a transmittance of the ND filter in a case where the ND filter is used. Therefore, in the AR glasses or the like where the ND filter is used, not only the transmittance of light incident from the upper side but also the transmittance incident from the front direction, that is, the background decrease.

As a result, in AR glasses or the like using the ND filter, the visibility problem caused by the external light can be suppressed, but the background may have poor visibility due to the background being darkened.

An object of the present invention is to solve such a problem, and to provide an optical member that can be used in a head-mounted display such as AR glasses in which a background can be visually recognized, the optical member having excellent brightness of the background and capable of suppressing a visibility problem caused by external light incident from above a head of a user using the head-mounted display, and AR glasses using the optical member.

The present inventors have found that the above-described objects can be achieved by the following configurations.

[1] An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more,
the polarization control layer is a λ/4 film, and
in a case where the optical member is arranged in a use configuration, an angle between a slow axis of the λ/4 film and a horizontal direction is 0° to 20°.

[2] An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer includes a first λ/4 film and a second λ/4 film, and an angle between a slow axis of the first λ/4 film and a slow axis of the second λ/4 film is 30° to 60°.

[3] The optical member according to [2],
in which the polarization control layer includes the first λ/4 film, the second λ/4 film, and a C-plate.

[4] An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer is a layer containing a liquid crystal compound having a twisted structure of one or more layers.

[5] The optical member according to [4],
in which the polarization control layer includes, in order from a side on which the diffraction element is disposed, the layer containing a liquid crystal compound having a twisted structure of one or more layers and a C-plate.

[6] AR glasses comprising:
the optical member according to any one of [1] to [5].

According to the present invention, it is possible to provide an optical member that can be used in a head-mounted display such as AR glasses in which a background can be visually recognized, the optical member having excellent brightness of the background and capable of suppressing a visibility problem caused by external light incident from above a head of a user.

In addition, according to the present invention, AR glasses using the optical member can also be provided.

### BRIEF DESCRIPTION OF THE DRAWINGS

FIG. 1 is a side view conceptually showing an example of an image display device using a first optical member.

FIG. 2 is a side view conceptually showing an example of an image display device using a second optical member.

FIG. 3 is a side view conceptually showing an example of an image display device using a third optical member.

### DESCRIPTION OF THE PREFERRED EMBODIMENTS

Hereinafter, the present invention will be described in detail. In the present specification, numerical ranges represented by “to” include numerical values before and after “to” as lower limit values and upper limit values.

In the present specification, Re(λ) and Rth(λ) represent an in-plane retardation (nm) and a thickness-direction retardation (nm) at a wavelength λ, respectively. Re(λ) is measured by causing light having the wavelength 2 nm to be incident in a film normal direction in AxoScan (manufactured by Axometrics Inc.).

In a case of simply using Re and Rth, values at λ=550 nm are indicated.

In a case where the film to be measured is represented by a uniaxial or biaxial index ellipsoid, Rth(λ) is calculated using the following method. In a case where the measurement wavelength λ nm is selected, the measurement can be performed by manually replacing a wavelength selective filter or by converting a measured value with a program or the like.

Rth(λ) is obtained using a method including: measuring Re(λ) at seven points in total in a case where an in-plane slow axis is used as a tilt axis (rotation axis) and light having the wavelength 2 nm is incident from a direction tilted from the normal direction to 60 degrees on one side with respect to the film normal direction at steps of 10 degrees; and calculating Rth(λ) using AxoScan based on the measured retardation values, an assumed value of an average refractive index, and an input film thickness value. In this case, the film in-plane slow axis is determined by AxoScan. In addition, in a case where a slow axis is not present in a plane of the film, any direction in the plane of the film is set as the rotation axis.

In the case of a film having a direction in which a retardation value is zero at one tilt angle from the normal direction with respect to the in-plane slow axis as a rotation axis, a retardation value at a tilt angle more than the tilt angle is calculated by AxoScan after changing the sign into minus.

The retardation value can be measured from any two inclined directions with the slow axis as a tilt axis (rotation axis), and Rth can be calculated from the following Expression (I) and Expression (II) based on the value, the assumed value of the average refractive index, and the input film thickness value. Even in this case, in a case where a slow axis is not present in a plane of the film, any direction in the plane of the film is set as the rotation axis.

$$\begin{matrix}Expression 1 & \\ Re ( θ ) = [ nx = \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & EXPRESSION ( I )\end{matrix}$$

$$Rth = \{ ( nx + ny ) / 2 - nz \} \times d \qquad EXPRESSION ( II )$$

In the expressions, Re(θ) represents a retardation value in a direction tilted at an angle θ from the normal direction.

In addition, nx represents a refractive index in a slow axis direction in a plane, ny represents a refractive index in a direction orthogonal to nx in the plane, nz represents a refractive index in a direction orthogonal to nx and ny, and d represents a film thickness.

In a case where the film to be measured is a film that cannot be represented by a uniaxial or biaxial index ellipsoid and does not have a so-called optic axis, Rth(λ) is calculated using the following method.

Rth(λ) is obtained using a method including: measuring Re(λ) at 13 points in a case where an in-plane slow axis is used as a tilt axis (rotation axis) and light having the wavelength λ nm is incident from a direction tilted from −60 degrees to 60 degrees with respect to the film normal direction at steps of 10 degrees; and calculating Rth(λ) using AxoScan based on the measured retardation values, an assumed value of an average refractive index, and an input film thickness value. In this case, the film in-plane slow axis is determined by AxoScan.

In addition, in the above-described measurement, as the assumed value of the average refractive index, values described in “Polymer Handbook” (John Wiley&Sons, Inc.) and catalogs of various optical compensation films can be used.

In addition, regarding films of which average refractive index values are not known, the average refractive index values are measured using an Abbe refractometer. Examples of average refractive index values of main optical compensation films are as follows:
cellulose acylate (1.48), a cycloolefin polymer (1.52), polycarbonate (1.59), polymethyl methacrylate (1.49), and polystyrene (1.59).

By inputting the assumed value of the average refractive index and the film thickness, AxoScan calculates nx, ny, and nz. Based on the calculated nx, ny, and nz, Nz=(nx−nz)/(nx−ny) is further calculated.

Unless otherwise specified, Re, Rth, and the measurement wavelength of the refractive index are values at λ=550 nm in a visible range.

In addition, in the present specification, “main axis” represents a main refractive index axis of an index ellipsoid calculated by AxoScan. Regarding, nx, ny, and nz, unless otherwise specified, “main axis” represents a main refractive index nz in a film thickness direction.

In the present specification, the transmittance is measured by causing light having a wavelength of 550 nm to be incident on AxoScan of Axometrics, Inc.

In the present specification, the circular polarization degree is a value represented by {|IR−IL|/(IR+IL)}×100(%), in a case where an intensity of a right circularly polarized light component of light is IR and an intensity of a left circularly polarized light component of light is IL.

The circular polarization degree can be measured using a spectroradiometer or a spectrometer with a circularly polarizing plate mounted thereon. In addition, although a normal light source such as an incandescent lamp, a mercury lamp, a fluorescent lamp, and an LED emits almost natural light, a characteristic of producing polarization of a circularly polarizing filter or a circularly polarizing separation layer mounted on the normal light source can be measured, for example, using a polarization phase difference analysis device AxoScan manufactured by Axometrics, Inc.

In addition, the measurement can be performed by attaching a circularly polarizing filter to a lux meter or an optical spectrometer. The amount of dextrorotatory circularly polarized light is measured by attaching a dextrorotatory circular polarization transmission plate thereto, the amount of levorotatory circularly polarized light is measured by attaching a levorotatory circular polarization transmission plate thereto, and thus, a ratio therebetween can be measured. Unless otherwise specified, the circular polarization degree in the present specification represents the circular polarization degree at a wavelength of 550 nm.

Hereinafter, the optical member (first to third optical members) according to the embodiment of the present invention will be described. In the following, the optical member and the image display device (AR glasses) according to the embodiment of the present invention will be described with reference to an example, but the present invention is not limited to the example shown below, and various improvements and modifications can be made within the scope of the spirit of the present invention.

### [First Optical Member]

A first optical member according to the embodiment of the present invention is an optical member including:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more,
the polarization control layer is a λ/4 film, and
in a case where the optical member is arranged in a use configuration, an angle between a slow axis of the λ/4 film and a horizontal direction is 0° to 20°.

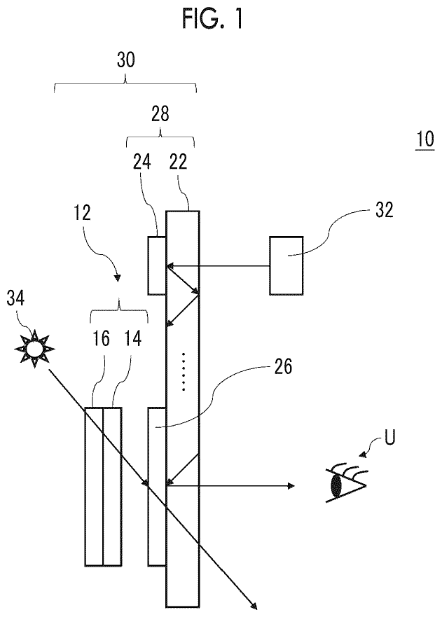

Here, the angle between the slow axis of the λ/4 film and the horizontal direction in a case where the optical member is arranged in the use configuration means an angle between the in-plane slow axis of the λ/4 film and the horizontal direction in a case where a head-mounted display (for example, an image display device such as AR glasses) including the optical member is used. More specifically, in a case where the optical member is used as a member of a head-mounted display, as shown in FIG. 1, the optical member is used such that the in-plane direction thereof is along the vertical direction, and the angle means an angle between the in-plane slow axis of the λ/4 film and the horizontal direction in a case of the use configuration.

Hereinafter, an example of an embodiment of the first optical member will be described with reference to the drawings. In the following, an example of an image display device using the first optical member will be described, and the configuration and function of the first optical member will be described. The image display device comprises the first optical member and a display element that emits an image to an incidence diffraction element in the first optical member.

FIG. 1 is a side view conceptually showing an example of an image display device using the first optical member.

As a suitable example, an image display device 10 shown in FIG. 1 is used as an AR glass. The first optical member can be used as an optical element such as a transparent screen, an illumination device (including a backlight of a liquid crystal display), and a sensor, in addition to AR glasses.

The image display device 10 shown in FIG. 1 includes an optical member 30 comprising an optical film 12 having a polarization control layer 14 and an optical absorption anisotropic layer 16, and a light guide member 28 disposed on a side of the optical film 12 where the polarization control layer 14 is provided, and a display element 32. The light guide member 28 includes a light guide plate 22 and an incidence diffraction element 24 and an emission diffraction element 26 disposed on a main surface of the light guide plate 22.

In the image display device 10 shown in FIG. 1, the incidence diffraction element 24 and the emission diffraction element 26 are disposed at different positions in the plane direction of the main surface of the light guide plate 22, and the emission diffraction element 26 is disposed below the incidence diffraction element 24. The main surface is a maximum surface of a sheet-like material (a plate-like material, a film, and the like). In addition, the display element 32 is disposed to face a surface of the light guide plate 22 opposite to a side where the incidence diffraction element 24 of the light guide plate 22 is disposed at a position overlapping the incidence diffraction element 24 in the plane direction of the main surface of the light guide plate 22.

The incidence diffraction element 24 and the emission diffraction element 26 are reflective diffraction elements that diffract light while reflecting the light. In addition, the emission diffraction element 26 is a diffraction element in which a diffraction efficiency changes depending on a polarization direction. That is, the emission diffraction element 26 is a polarization diffraction element that selectively diffracts light in a polarization state, and exhibits different diffraction efficiencies depending on a polarization direction of the light. Examples of the emission diffraction element 26 include a diffraction element in which a diffraction efficiency with respect to one of right circularly polarized light (right circularly polarized light) and left circularly polarized light (left circularly polarized light) is large and a diffraction efficiency with respect to the other of the right circularly polarized light and the left circularly polarized light is small or the diffraction element does not diffract the light, and a diffraction element in which a diffraction efficiency with respect to linearly polarized light is large and a diffraction efficiency with respect to circularly polarized light is small or the diffraction element does not diffract the light.

In the image display device 10, an image (light corresponding to the image) displayed by the display element 32 is incident on the incidence diffraction element 24 from a direction perpendicular to the main surface of the light guide plate 22. The light incident on the incidence diffraction element 24 is diffracted by the incidence diffraction element 24 and is incident on the light guide plate 22. In this case, the incidence diffraction element 24 diffracts the light at an angle at which the light is totally reflected in the light guide plate 22, and diffracts the light such that a traveling direction of the diffracted light is a direction toward the emission diffraction element 26. In the example shown in FIG. 1, the incidence diffraction element 24 diffracts the incident light in a downward direction in FIG. 1.

The diffracted light by the incidence diffraction element 24 is totally reflected in the light guide plate 22 and propagates, and is incident on the emission diffraction element 26. The emission diffraction element 26 diffracts the incident light to deviate from the angle at which total reflection occurs in the light guide plate 22. In the example shown in FIG. 1, the emission diffraction element 26 diffracts the incident light toward a right side in FIG. 1. That is, as shown in FIG. 1, the emission diffraction element 26 diffracts the incident light in a direction substantially perpendicular to the main surface of the light guide plate.

The light diffracted by the emission diffraction element 26 is emitted from the light guide plate 22 to the user U. As a result, the image display device 10 can display the image emitted by the display element 32.

The optical member 30 includes the optical film 12 having the polarization control layer 14 and the optical absorption anisotropic layer 16. In the image display device 10 shown in FIG. 1, the optical film 12 is disposed on a side of the emission diffraction element 26 opposite to the light guide plate 22. That is, the optical film 12 is disposed on a side opposite to the emission side with respect to the emission diffraction element 26. In addition, the optical film 12 is disposed at a position overlapping the emission diffraction element 26 in the plane direction of the main surface of the light guide plate 22 such that the polarization control layer 14 faces the emission diffraction element 26.

An angle between a transmittance central axis of the optical absorption anisotropic layer 16 and a normal direction of the optical absorption anisotropic layer 16 is 0° to 45°. The optical absorption anisotropic layer 16 typically includes a dichroic substance, and a direction of an absorption axis of the dichroic substance (a direction of a long axis of a molecule) is substantially the same as the transmittance central axis of the optical absorption anisotropic layer 16. That is, in the optical absorption anisotropic layer 16, the dichroic substance is aligned such that the absorption axis is substantially perpendicular to the main surface. Since the angle between the transmittance central axis of the optical absorption anisotropic layer 16 and the normal direction of the optical absorption anisotropic layer 16 is 0° to 45°, the transmittance of the optical film 12 with respect to light from the front is likely to be high, and the transmittance is likely to be low from an oblique angle because only S-polarized light can pass through. The definition and a measurement method of the transmittance central axis of the optical absorption anisotropic layer 16 will be described in a later section.

The polarization control layer 14 is a λ/4 film, and is disposed such that an angle between a slow axis (in-plane slow axis) of the polarization control layer 14 that is the λ/4 film and the horizontal direction is 0° to 20°. The horizontal direction is a horizontal direction in a case where the optical member is arranged in the use configuration, and more specifically, the angle means an angle between the slow axis (in-plane slow axis) of the polarization control layer 14 and the horizontal direction in a situation where a head-mounted display such as the image display device 10 is appropriately mounted on the user and is appropriately used in a normal situation.

From the viewpoint that the deterioration in visibility of the background caused by the external light incident from above the head of the user U can be further suppressed, the angle between the slow axis (in-plane slow axis) of the polarization control layer 14 that is the λ/4 film and the horizontal direction is preferably more than 0° and 20° or less, and more preferably 5° to 15°.

In the optical film 12, a circular polarization degree in a direction at an angle of 60° with respect to a normal direction of the optical film 12 at an azimuthal angle in at least one direction is 50% or more. In other words, in a case where light is incident on the optical film 12 at a slope at which the polar angle is 60° with respect to the normal direction of the optical film 12, the circular polarization degree is 50% or more at an azimuthal angle in at least one direction. The upper limit of the circular polarization degree is not particularly limited, but is 100% or less.

The circular polarization degree is measured by causing light to be incident from the optical absorption anisotropic layer side.

Since the optical film 12 has a circular polarization degree of 50% or more in a direction at an angle of 60° with respect to the normal direction of the optical film 12 at an azimuthal angle in at least one direction, as will be described later, the light transmitted through the polarization control layer 14 and incident on the light guide member 28 is less likely to be diffracted, and the visibility of the background caused by the external light incident from above the head of the user U is excellent.

From the viewpoint that the visibility of the background caused by the external light incident from above the head of the user U is more excellent, the circular polarization degree of the optical film 12 is more preferably 60% to 100% and still more preferably 75% to 100%.

In addition, the transmittance of the optical film 12 in the normal direction is 55% or more. The upper limit of the transmittance of the optical film 12 in the normal direction is not particularly limited, but is 100% or less.

In addition, the transmittance of the optical film 12 in a direction at an angle of 30° with respect to the normal direction is 25% or more. That is, the transmittance in a case where light is incident on the optical film 12 at a slope at which the polar angle is 30° with respect to the normal direction of the optical film 12 is 25% or more. The upper limit of the transmittance of the optical film 12 in a direction at an angle of 30° with respect to the normal direction is not particularly limited, but is 100% or less.

The transmittance is measured by causing light to be incident from the optical absorption anisotropic layer side.

The transmittance can be achieved by setting the angle between the transmittance central axis of the optical absorption anisotropic layer 16 and the normal direction of the optical absorption anisotropic layer 16 to 0° to 45° and appropriately adjusting the layer configuration of the optical film 12. The optical film used in the optical member of Comparative Example 2 shown in the Examples section has two optical absorption anisotropic layers, and thus the transmittance in a direction at an angle of 30° with respect to the normal direction of the optical film does not satisfy a predetermined value.

In a case where the image display device 10 is used, the external light incident from above the head of the user U (light incident from a light source 34 in an oblique direction to the image display device 10) passes through the optical absorption anisotropic layer 16 to be linearly polarized light that vibrates in a predetermined direction, and is further incident on the polarization control layer 14 to be converted into right circularly polarized light or left circularly polarized light (circularly polarized light having a polarization direction in which the diffraction efficiency is low or the light is not diffracted in the emission diffraction element 26). That is, in a case where the light selectively diffracted by the emission diffraction element 26 is right circularly polarized light, the light is converted into left circularly polarized light by the polarization control layer 14.

The light transmitted through the polarization control layer 14 is incident on the light guide member 28, but is circularly polarized light in a polarization direction in which the diffraction efficiency is low or the light is not diffracted in the emission diffraction element 26, and thus the diffraction in the emission diffraction element 26 is suppressed, and the light is less likely to enter the eyes of the user U. That is, as a result, the deterioration in visibility of the background caused by the external light incident from above the head of the user U can be suppressed.

As described above, it is preferable that a rotation direction of a larger component of the right circularly polarized light and the left circularly polarized light emitted through the optical member is opposite to a rotation direction of the circularly polarized light diffracted by the diffraction element. More specifically, it is preferable that a rotation direction of a larger component of the right circularly polarized light and the left circularly polarized light emitted through the optical film in a direction in which the circular polarization degree in a direction at an angle of 60° with respect to the normal direction of the optical film is 50% or more is opposite to a rotation direction of the circularly polarized light diffracted by the diffraction element.

The optical film 12 need only be disposed to overlap at least a part of the emission diffraction element 26 in a case of being viewed from a direction perpendicular to the main surface of the light guide plate 22, but is preferably disposed to cover the entire surface as shown in FIG. 1.

In addition, in the example shown in FIG. 1, the optical film 12 is disposed to be spaced from the light guide member 28, but the present invention is not limited to the above configuration, and the optical film 12 may be disposed to be in contact with the light guide member 28.

In addition, in the example shown in FIG. 1, the configuration in which the incidence diffraction element 24 and the emission diffraction element 26 are provided on the main surface of the light guide plate 22 is shown as the light guide member 28, but the light guide member 28 may have an intermediate diffraction element.

In addition, in the example shown in FIG. 1, the configuration in which the reflective diffraction element (the incidence diffraction element 24 and the emission diffraction element 26) is provided on the main surface of the light guide plate is shown as the light guide member 28, but the light guide member may be a light guide member that comprises the incidence diffraction element and the emission diffraction element, which are transmissive diffraction elements, on the main surface of the light guide plate.

### [Second Optical Member]

A second optical member according to the embodiment of the present invention is an optical member including:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer includes a first λ/4 film and a second λ/4 film, and an angle between a slow axis of the first λ/4 film and a slow axis of the second λ/4 film is 30° to 60°.

Hereinafter, an example of an embodiment of the second optical member will be described with reference to the drawings. In the following, an example of an image display device using the second optical member will be described, and the configuration and function of the second optical member will be described. The image display device comprises the second optical member and a display element that emits an image to an incidence diffraction element in the second optical member.

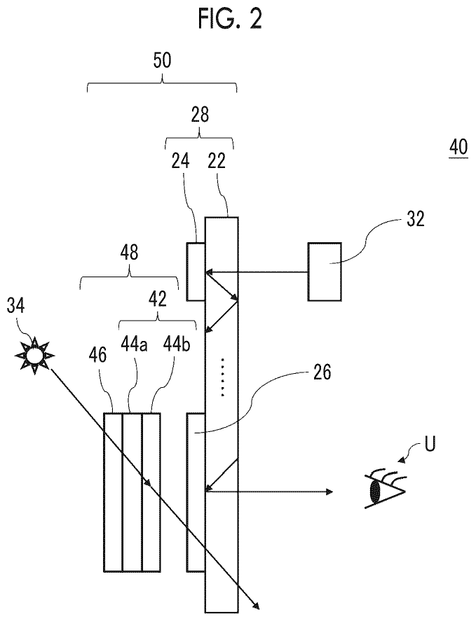

FIG. 2 is a side view conceptually showing an example of an image display device using the second optical member.

As a suitable example, an image display device 40 shown in FIG. 2 is used as an AR glass. The second optical member can be used as an optical element such as a transparent screen, an illumination device (including a backlight of a liquid crystal display), and a sensor, in addition to AR glasses.

The image display device 40 shown in FIG. 2 includes an optical member 50 comprising an optical film 48 having a polarization control layer 42 and an optical absorption anisotropic layer 46, and a light guide member 28 disposed on a side of the optical film 48 where the polarization control layer 42 is provided, and a display element 32. The configuration of the image display device 40 shown in FIG. 2 is the same as the configuration of the image display device 10 shown in FIG. 1, except that the optical film 12 in the image display device 10 shown in FIG. 1 is changed to the optical film 48. Therefore, only the configuration and function of the optical member 50 will be described below.

The optical member 50 includes the optical film 48 having the polarization control layer 42 and the optical absorption anisotropic layer 46. In the image display device 40 shown in FIG. 2, the optical film 48 is disposed on a side of the emission diffraction element 26 opposite to the light guide plate 22. That is, the optical film 48 is disposed on a side opposite to the emission side with respect to the emission diffraction element 26. In addition, the optical film 48 is disposed at a position overlapping the emission diffraction element 26 in the plane direction of the main surface of the light guide plate 22 such that the polarization control layer 42 faces the emission diffraction element 26.

In the optical absorption anisotropic layer 46, an angle between a transmittance central axis of the optical absorption anisotropic layer 46 and a normal direction of the optical absorption anisotropic layer 46 is 0° to 45°. The optical absorption anisotropic layer 46 typically includes a dichroic substance, and a direction of an absorption axis of the dichroic substance (a direction of a long axis of a molecule) is substantially the same as the transmittance central axis of the optical absorption anisotropic layer 46. That is, in the optical absorption anisotropic layer 46, the dichroic substance is aligned such that the absorption axis is substantially perpendicular to the main surface. Since the angle between the transmittance central axis of the optical absorption anisotropic layer 46 and the normal direction of the optical absorption anisotropic layer 46 is 0° to 45°, the transmittance of the optical film 48 with respect to light from the front is likely to be high, and the transmittance is likely to be low from an oblique angle because only S-polarized light can pass through. The definition and a measurement method of the transmittance central axis of the optical absorption anisotropic layer 46 will be described in a later section.

The polarization control layer 42 is composed of a first λ/4 film 44a and a second λ/4 film 44b. The first λ/4 film 44a and the second λ/4 film 44b are disposed such that an angle between a slow axis (in-plane slow axis) of the first λ/4 film 44a and a slow axis (in-plane slow axis) of the second λ/4 film 44b is 30° to 60°.

In addition, an angle between the slow axis (in-plane slow axis) of the second λ/4 film 44b and the horizontal direction in a case where the second optical member 50 is arranged in the use configuration is desirably 0° to 45°, more desirably 0° to 20°, and still more desirably 0° to 10°.

Here, the angle between the slow axis (in-plane slow axis) of the first λ/4 film and the horizontal direction in a case where the optical member is arranged in the use configuration means an angle between the slow axis (in-plane slow axis) of the first λ/4 film and the horizontal direction in a case where a head-mounted display (for example, an image display device such as AR glasses) including the optical member is used. More specifically, the angle means an angle between the slow axis (in-plane slow axis) of the first λ/4 film and the horizontal direction in a situation where a head-mounted display such as the image display device 40 is appropriately mounted on the user and is appropriately used in a normal situation.

By setting the polarization control layer 42 to the above configuration, the optical film 48 of the second optical member has an advantage that an angle width of an azimuthal angle at which the circular polarization degree in a direction at an angle of 60° with respect to the normal direction of the optical film 48 is 50% or more is wider than that of the optical film 12 of the first optical member.

In the optical film 48, a circular polarization degree in a direction at an angle of 60° with respect to a normal direction of the optical film 48 at an azimuthal angle in at least one direction is 50% or more. In other words, in a case where light is incident on the optical film 48 at a slope at which the polar angle is 60° with respect to the normal direction of the optical film 48, the circular polarization degree is 50% or more at an azimuthal angle in at least one direction. The upper limit of the circular polarization degree is not particularly limited, but is 100% or less.

The circular polarization degree is measured by causing light to be incident from the optical absorption anisotropic layer side.

Since the optical film 48 has a circular polarization degree of 50% or more in a direction at an angle of 60° with respect to the normal direction of the optical film 48 at an azimuthal angle in at least one direction, as will be described later, the light transmitted through the polarization control layer 42 and incident on the light guide member 28 is less likely to be diffracted, and the visibility of the background caused by the external light incident from above the head of the user U is excellent.

From the viewpoint that the visibility of the background caused by the external light incident from above the head of the user U is more excellent, the circular polarization degree of the optical film 48 is more preferably 60% to 100% and still more preferably 75% to 100%.

In addition, the transmittance of the optical film 48 in the normal direction is 55% or more. The upper limit of the transmittance of the optical film 48 in the normal direction is not particularly limited, but is 100% or less.

In addition, the transmittance of the optical film 48 in a direction at an angle of 30° with respect to the normal direction is 25% or more. That is, the transmittance in a case where light is incident on the optical film 48 at a slope at which the polar angle is 30° with respect to the normal direction of the optical film 48 is 25% or more. The upper limit of the transmittance of the optical film 48 in a direction at an angle of 30° with respect to the normal direction is not particularly limited, but is 100% or less.

The transmittance is measured by causing light to be incident from the optical absorption anisotropic layer side.

The transmittance can be achieved by setting the angle between the transmittance central axis of the optical absorption anisotropic layer 46 and the normal direction of the optical absorption anisotropic layer 46 to 0° to 45° and appropriately adjusting the layer configuration of the optical film 48.

In a case where the image display device 40 is used, the external light incident from above the head of the user U (light incident from a light source 34 in an oblique direction to the image display device 40) passes through the optical absorption anisotropic layer 46 to be linearly polarized light that vibrates in a predetermined direction, and is further incident on the polarization control layer 42 to be converted into right circularly polarized light or left circularly polarized light (circularly polarized light having a polarization direction in which the diffraction efficiency is low or the light is not diffracted in the emission diffraction element 26). That is, in a case where the light selectively diffracted by the emission diffraction element 26 is right circularly polarized light, the light is converted into left circularly polarized light by the polarization control layer 42. The light transmitted through the polarization control layer 42 is incident on the light guide member 28, but is circularly polarized light in a polarization direction in which the diffraction efficiency is low or the light is not diffracted in the emission diffraction element 26, and thus the diffraction in the emission diffraction element 26 is suppressed, and the light is less likely to enter the eyes of the user U. That is, as a result, the deterioration in visibility of the background caused by the external light incident from above the head of the user U can be suppressed.

As described above, it is preferable that a rotation direction of a larger component of the right circularly polarized light and the left circularly polarized light emitted through the optical member is opposite to a rotation direction of the circularly polarized light diffracted by the diffraction element. More specifically, it is preferable that a rotation direction of a larger component of the right circularly polarized light and the left circularly polarized light emitted through the optical film in a direction in which the circular polarization degree in a direction at an angle of 60° with respect to the normal direction of the optical film is 50% or more is opposite to a rotation direction of the circularly polarized light diffracted by the diffraction element.

The optical film 48 need only be disposed to overlap at least a part of the emission diffraction element 26 in a case of being viewed from a direction perpendicular to the main surface of the light guide plate 22, but is preferably disposed to cover the entire surface as shown in FIG. 2.

In addition, in the example shown in FIG. 2, the optical film 48 is disposed to be spaced from the light guide member 28, but the present invention is not limited to the above configuration, and the optical film 48 may be disposed to be in contact with the light guide member 28.

In addition, in the example shown in FIG. 2, the configuration in which the incidence diffraction element 24 and the emission diffraction element 26 are provided on the main surface of the light guide plate 22 is shown as the light guide member 28, but the light guide member 28 may have an intermediate diffraction element.

In addition, in the example shown in FIG. 2, the configuration in which the reflective diffraction element (the incidence diffraction element 24 and the emission diffraction element 26) is provided on the main surface of the light guide plate is shown as the light guide member 28, but the light guide member may be a light guide member that comprises the incidence diffraction element and the emission diffraction element, which are transmissive diffraction elements, on the main surface of the light guide plate.

In addition, in the example shown in FIG. 2, the polarization control layer 42 has a two-layer configuration of the first λ/4 film 44a and the second λ/4 film 44b, but the polarization control layer 42 may have another optically anisotropic layer between the first λ/4 film 44a and the second λ/4 film 44b. Examples of the other optically anisotropic layer include a positive C-plate.

### [Third Optical Member]

A third optical member according to the embodiment of the present invention is an optical member including:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
in which an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer is a layer containing a liquid crystal compound having a twisted structure of one or more layers.

Hereinafter, an example of an embodiment of the third optical member will be described with reference to the drawings. In the following, an example of an image display device using the third optical member will be described, and the configuration and function of the third optical member will be described. The image display device comprises the third optical member and a display element that emits an image to an incidence diffraction element in the third optical member.

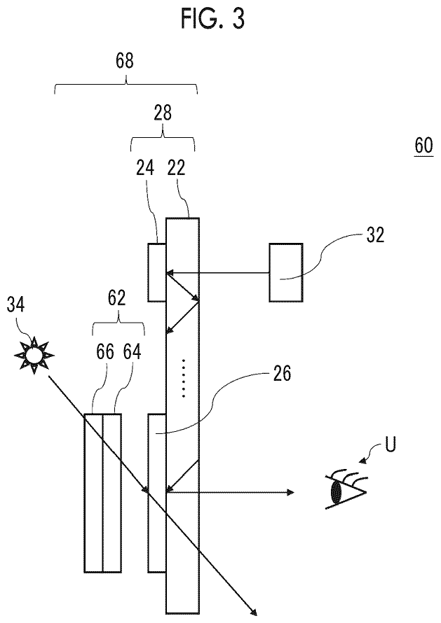

FIG. 3 is a side view conceptually showing an example of an image display device using the third optical member.

As a suitable example, an image display device 60 shown in FIG. 3 is used as an AR glass. The third optical member can be used as an optical element such as a transparent screen, an illumination device (including a backlight of a liquid crystal display), and a sensor, in addition to AR glasses.

The image display device 60 shown in FIG. 3 includes an optical member 68 comprising an optical film 62 having a polarization control layer 64 and an optical absorption anisotropic layer 66, and a light guide member 28 disposed on a side of the optical film 62 where the polarization control layer 64 is provided, and a display element 32. The configuration of the image display device 60 shown in FIG. 3 is the same as the configuration of the image display device 10 shown in FIG. 1, except that the optical film 12 in the image display device 10 shown in FIG. 1 is changed to the optical film 62. Therefore, only the configuration and function of the optical member 68 will be described below.

The optical member 68 includes the optical film 62 having the polarization control layer 64 and the optical absorption anisotropic layer 66. In the image display device 60 shown in FIG. 3, the optical film 62 is disposed on a side of the emission diffraction element 26 opposite to the light guide plate 22. That is, the optical film 62 is disposed on a side opposite to the emission side with respect to the emission diffraction element 26. In addition, the optical film 62 is disposed at a position overlapping the emission diffraction element 26 in the plane direction of the main surface of the light guide plate 22 such that the polarization control layer 64 faces the emission diffraction element 26.

In the optical absorption anisotropic layer 66, an angle between a transmittance central axis of the optical absorption anisotropic layer 66 and a normal direction of the optical absorption anisotropic layer 66 is 0° to 45°. The optical absorption anisotropic layer 66 typically includes a dichroic substance, and a direction of an absorption axis of the dichroic substance (a direction of a long axis of a molecule) is substantially the same as the transmittance central axis of the optical absorption anisotropic layer 66. That is, in the optical absorption anisotropic layer 66, the dichroic substance is aligned such that the absorption axis is substantially perpendicular to the main surface. Since the angle between the transmittance central axis of the optical absorption anisotropic layer 66 and the normal direction of the optical absorption anisotropic layer 66 is 0° to 45°, the transmittance of the optical film 62 with respect to light from the front is likely to be high, and the transmittance is likely to be low from an oblique angle because only S-polarized light can pass through. The definition and a measurement method of the transmittance central axis of the optical absorption anisotropic layer 66 will be described in a later section.

The polarization control layer 64 is a layer containing a liquid crystal compound having one or more twisted structures (hereinafter, also referred to as a “twist layer”). The twist layer is, in detail, a layer formed by immobilizing a liquid crystal compound twisted and aligned along a helical axis extending in the thickness direction (a twisted angle of the liquid crystal compound is typically 360° or less and preferably less than 360°), and has a function of rotating linearly polarized light incident perpendicularly to the twist layer in the plane.

In addition, an angle between the slow axis (in-plane slow axis) of the twist layer on the optical absorption anisotropic layer 62 side and the horizontal direction in a case where the third optical member 68 is arranged in the use configuration is desirably 5° to 75°, more desirably 5° to 45°, and still more desirably 10° to 35°

Here, the angle between the slow axis (in-plane slow axis) of the twist layer on the optical absorption anisotropic layer 62 side and the horizontal direction in a case where the optical member is arranged in the use configuration means an angle between the slow axis (in-plane slow axis) of the twist layer on the optical absorption anisotropic layer 62 side and the horizontal direction in a case where a head-mounted display (for example, an image display device such as AR glasses) including the optical member is used. More specifically, the angle means a horizontal direction in a situation where a head-mounted display such as the image display device 60 is appropriately mounted on the user and is appropriately used in a normal situation.

In the optical film 62, a circular polarization degree in a direction at an angle of 60° with respect to a normal direction of the optical film 62 at an azimuthal angle in at least one direction is 50% or more. In other words, in a case where light is incident on the optical film 62 at a slope at which the polar angle is 60° with respect to the normal direction of the optical film 62, the circular polarization degree is 50% or more at an azimuthal angle in at least one direction. The upper limit of the circular polarization degree is not particularly limited, but is 100% or less.

The circular polarization degree is measured by causing light to be incident from the optical absorption anisotropic layer side.

Since the optical film 62 has a circular polarization degree of 50% or more in a direction at an angle of 60° with respect to the normal direction of the optical film 62 at an azimuthal angle in at least one direction, as will be described later, the light transmitted through the polarization control layer 64 and incident on the light guide member 28 is less likely to be diffracted, and the visibility of the background caused by the external light incident from above the head of the user U is excellent.

From the viewpoint that the visibility of the background caused by the external light incident from above the head of the user U is more excellent, the circular polarization degree of the optical film 62 is more preferably 60% to 100% and still more preferably 75% to 100%.

In addition, the transmittance of the optical film 62 in the normal direction is 55% or more. The upper limit of the transmittance of the optical film 62 in the normal direction is not particularly limited, but is 100% or less.

In addition, the transmittance of the optical film 62 in a direction at an angle of 30° with respect to the normal direction is 25% or more. That is, the transmittance in a case where light is incident on the optical film 62 at a slope at which the polar angle is 30° with respect to the normal direction of the optical film 62 is 25% or more. The upper limit of the transmittance of the optical film 62 in a direction at an angle of 30° with respect to the normal direction is not particularly limited, but is 100% or less.

The transmittance is measured by causing light to be incident from the optical absorption anisotropic layer side.

The transmittance can be achieved by setting the angle between the transmittance central axis of the optical absorption anisotropic layer 66 and the normal direction of the optical absorption anisotropic layer 66 to 0° to 45° and appropriately adjusting the layer configuration of the optical film 62.

In a case where the image display device 60 is used, the external light incident from above the head of the user U (light incident from a light source 34 in an oblique direction to the image display device 60) passes through the optical absorption anisotropic layer 66 to be linearly polarized light that vibrates in a predetermined direction, and is further incident on the polarization control layer 64 to be converted into right circularly polarized light or left circularly polarized light (circularly polarized light having a polarization direction in which the diffraction efficiency is low or the light is not diffracted in the emission diffraction element 26). That is, in a case where the light selectively diffracted by the emission diffraction element 26 is right circularly polarized light, the light is converted into left circularly polarized light by the polarization control layer 64. The light transmitted through the polarization control layer 64 is incident on the light guide member 28, but is circularly polarized light in a polarization direction in which the diffraction efficiency is low or the light is not diffracted in the emission diffraction element 26, and thus the diffraction in the emission diffraction element 26 is suppressed, and the light is less likely to enter the eyes of the user U. That is, as a result, the deterioration in visibility of the background caused by the external light incident from above the head of the user U can be suppressed.

As described above, it is preferable that a rotation direction of a larger component of the right circularly polarized light and the left circularly polarized light emitted through the optical member is opposite to a rotation direction of the circularly polarized light diffracted by the diffraction element. More specifically, it is preferable that a rotation direction of a larger component of the right circularly polarized light and the left circularly polarized light emitted through the optical film in a direction in which the circular polarization degree in a direction at an angle of 60° with respect to the normal direction of the optical film is 50% or more is opposite to a rotation direction of the circularly polarized light diffracted by the diffraction element.

The optical film 62 need only be disposed to overlap at least a part of the emission diffraction element 26 in a case of being viewed from a direction perpendicular to the main surface of the light guide plate 22, but is preferably disposed to cover the entire surface as shown in FIG. 3.

In addition, in the example shown in FIG. 3, the optical film 62 is disposed to be spaced from the light guide member 28, but the present invention is not limited to the above configuration, and the optical film 62 may be disposed to be in contact with the light guide member 28.

In addition, in the example shown in FIG. 3, the configuration in which the incidence diffraction element 24 and the emission diffraction element 26 are provided on the main surface of the light guide plate 22 is shown as the light guide member 28, but the light guide member 28 may have an intermediate diffraction element.

In addition, in the example shown in FIG. 3, the configuration in which the reflective diffraction element (the incidence diffraction element 24 and the emission diffraction element 26) is provided on the main surface of the light guide plate is shown as the light guide member 28, but the light guide member may be a light guide member that comprises the incidence diffraction element and the emission diffraction element, which are transmissive diffraction elements, on the main surface of the light guide plate.

In addition, in the example shown in FIG. 3, the polarization control layer 64 has a single-layer configuration of the twist layer, but the polarization control layer 64 may have a configuration in which two or more twist layers are laminated, or may have another optically anisotropic layer on a side opposite to the optical absorption anisotropic layer of the twist layer. Examples of the other optically anisotropic layer include a positive C-plate.

### [Each Member of Optical Member]

### <Optical Film>

### (Polarization Control Layer)

The polarization control layer used in the optical member according to the embodiment of the present invention is a layer that can control linearly polarized light incident obliquely with respect to the plane of the polarization control layer to be circularly polarized light. In particular, it is preferable that the linearly polarized light can be more circularly polarized in a case where the linearly polarized light is incident from an oblique direction at an angle of 40° or more with respect to the normal direction of the polarization control layer.

Examples of the polarization control layer that converts the linearly polarized light into the circularly polarized light include a λ/4 film and a twist layer.

### <λ/4 Film>

The λ/4 film used in the optical member according to the embodiment of the present invention is a phase difference layer in which an in-plane phase difference is about ¼ of a wavelength, and specifically, refers to a phase difference layer in which an in-plane phase difference Re(550) at a wavelength of 550 nm is 100 nm to 180 nm. In addition, Rth of the λ/4 film used in the optical member according to the embodiment of the present invention is preferably −200 nm to 400 nm.

The λ/4 film used in the optical member according to the embodiment of the present invention is not particularly limited as long as the in-plane phase difference is about ¼ of the wavelength, but is preferably a layer formed of a composition containing a liquid crystal compound.

Here, in general, the liquid crystal compound can be classified into a rod-like type and a disk-like type according to the shape thereof. Furthermore, each type includes a low-molecular-type and a high-molecular-type. The term “high-molecular-weight” generally refers to a compound having a degree of polymerization of 100 or more (Polymer Physics-Phase Transition Dynamics, written by Masao Doi, page 2, published by Iwanami Shoten, 1992). In the optical member according to the embodiment of the present invention, any liquid crystal compound can be used, but a rod-like liquid crystal compound or a discotic liquid crystal compound (disk-like liquid crystal compound) is preferable. In addition, a liquid crystal compound which is a monomer or has a relatively low molecular weight with a degree of polymerization of less than 100 is preferable.

In addition, examples of the polymerizable group of the polymerizable liquid crystal compound include an acryloyl group, a methacryloyl group, an epoxy group, and a vinyl group.

By polymerizing such a polymerizable liquid crystal compound, the alignment of the liquid crystal compound can be immobilized. After immobilizing the liquid crystal compound by polymerization, it is no longer necessary to exhibit liquid crystallinity.

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. These rod-like liquid crystal compounds are fixed by introducing a polymerizable group to the terminal structure of the rod-like liquid crystal compound (the same as in the disk-like liquid crystal described later) and using a polymerization and curing reaction. As a specific example, curing a polymerizable nematic rod-like liquid crystal compound with ultraviolet rays is described in JP2006-209073A. In addition, as well as the above-described low-molecular-weight liquid crystal compound, a polymer liquid crystal compound can also be used. The polymer liquid crystal compound is a polymer having a side chain corresponding to the above-described low-molecular-weight liquid crystal compound. JP1993-053016A (JP-H5-053016A) or the like describes an optical compensation sheet formed of a polymer liquid crystal compound.

The disk-like liquid crystal compound includes benzene derivatives described in C. Destrade et. al.'s study report, “Mol. Cryst.”, vol. 71, page 111 (1981); truxene derivatives described in C. Destrade et. al.'s study report, “Mol. Cryst.”, vol. 122, page 141 (1985) and “Physics lett, A”, vol. 78, page 82 (1990); cyclohexane derivatives described in B. Kohne et. al.'s study report, “Angew. Chem.”, vol. 96, page 70 (1984); and azacrown-based or phenyl acetylene-based macrocycles described in J. M. Lehn et. al.'s study report, “J. Chem. Commun.”, page 1794 (1985) and J. Zhang et. al.'s study report, “J. Am. Chem. Soc.”, vol. 116, page 2655 (1994).

A compound in which molecules of a disk-like liquid crystal compound exhibit liquid crystallinity with a structure in which a linear alkyl group, alkoxy group, or substituted benzoyloxy group is radially substituted as a side chain of mother nuclei at the centers of the molecules is also included. A compound in which molecules or molecular aggregates have rotation symmetry and to which certain alignment can be given is preferable. A retardation layer formed from a composition containing a disk-like liquid crystal compound does not need to exhibit liquid crystallinity in a state of being finally included in the retardation layer. For example, in a case where low-molecular-weight disk-like liquid crystalline molecules having a group which reacts with heat or light are polymerized by heating or light irradiation to increase the molecular weight, the liquid crystallinity is lost, but a retardation layer containing such a polymer compound can also be used in the optical member according to the embodiment of the present invention. Preferable examples of the disk-like liquid crystal compound include compounds described in JP1996-050206A (JP-H8-050206A). In addition, the polymerization of the disk-like liquid crystalline molecules is described in JP1996-027284A (JP-H8-027284A).

In order to fix the disk-like liquid crystalline molecules by polymerization, it is necessary to bond a polymerizable group as a substituent to the disk-like cores of the disk-like liquid crystalline molecules. A compound in which the disk-like core and the polymerizable group are bonded via a linking group is preferable, whereby the compound can maintain the alignment state even under the polymerization reaction. Examples thereof include compounds described in paragraph Nos. [0151] to [0168] of the specification of JP2000-155216A.

The liquid crystal compound may have a normal wavelength dispersibility or an abnormal wavelength dispersibility.

### <C-Plate>

The C-plate used in the optical member according to the embodiment of the present invention includes two types of a positive C-plate (positive C-plate, +C-plate) and a negative C-plate (negative C-plate, −C-plate). The positive C-plate satisfies a relationship represented by Expression (C1) and the negative C-plate satisfies a relationship represented by Expression (C2). The positive C-plate has an Rth showing a negative value and the negative C-plate has an Rth showing a positive value.

$$nz > nx \approx ny \qquad Expression ( C 1 )$$

$$nz < nx \approx ny \qquad Expression ( C 2 )$$

The symbol “≈” encompasses not only a case where both sides are completely the same as each other but also a case where the both sides are substantially the same as each other. The expression “substantially the same” means that, for example, a case where (nx−ny)×d is 0 to 10 nm and preferably 0 to 5 nm is also included in “nx≈ny”. In (ny−nz)×d, d represents a thickness of the film.

Rth of the C-plate used in the optical member according to the embodiment of the present invention is preferably −500 nm to −10 nm or 10 nm to 500 nm.

### <Twist Layer>

The twist layer used in the optical member according to the embodiment of the present invention is a layer formed by immobilizing a liquid crystal compound twisted and aligned along a helical axis extending in the thickness direction. The twist layer is an optically active element. Having optical rotation represents that linearly polarized light rotates and propagates in a medium substantially without any change from linearly polarized light. Therefore, the twist layer has a function of rotating linearly polarized light incident perpendicularly to the twist layer in the plane.

A twisted angle of the liquid crystal compound in the twist layer is not particularly limited, but is preferably 20° to 360°. The twisted angle is measured using an AxoScan (polarimeter) device of Axometrics, Inc. and using device analysis software of Axometrics, Inc.

Δnd of the phase difference layer is not particularly limited, but is preferably 200 to 1000 nm.

Δn represents refractive index anisotropy of the phase difference layer at a wavelength of 550 nm, and d represents a thickness (nm) of the phase difference layer.

From the viewpoint of ease of production, it is preferable that the refractive index anisotropic layer having a twisted structure is a film having a twisted structure formed by adding a chiral material to a rod-like or disk-like liquid crystal compound. Further, from the viewpoint of reducing the thickness, the refractive index anisotropic layer can be prepared to be thinner than the retardation layer formed of a polymer. Meanwhile, it is difficult to use a polymer film from the viewpoint of production because a plurality of polymer films are bonded to each other by gradually changing the angles of the slow axes of the polymer films in the plane in order to obtain the twisted structure and the optically rotatory property. As the polymer film, a cellulose acylate-based film, a cycloolefin-based polymer film (a polymer film formed of a cycloolefin-based polymer), a polycarbonate-based polymer film, a polystyrene-based polymer film, or an acrylic polymer film is preferable. It is preferable that the acrylic polymer film contains an acrylic polymer having at least one unit selected from a lactone ring unit, a maleic acid anhydride unit, or a glutaric anhydride unit.

### (Optical Absorption Anisotropic Layer)

The optical absorption anisotropic layer includes a dichroic colorant, and an angle between an absorption axis of the dichroic colorant and the normal line of the main surface is 0° to 45°.

By aligning the absorption axis of the optical absorption anisotropic layer to be substantially perpendicular to the main surface, the transmittance is high from the front, and the transmittance is low from an oblique angle because only S-polarized light can pass through.

On the other hand, by aligning the absorption axis of the optical absorption anisotropic layer to be parallel to the main surface, an optical absorption anisotropic layer having the same optical performance as an iodine-based polarizer that is generally known can be obtained, the iodine-based polarizer being obtained by impregnating a polyvinyl alcohol (PVA) stretched film with polyiodide ions.

Here, the alignment of the absorption axis of the optical absorption anisotropic layer substantially in the direction perpendicular to the main surface (horizontal reference surface) can be verified, for example, by observing a cross section of the optical absorption anisotropic layer with a transmission electron microscope (TEM).

A technique for aligning a dichroic colorant as desired can refer to a technique of preparing a polarizer using a dichroic colorant, a technique of preparing a guest-host liquid crystal cell, and the like.

For example, a technique used in a method of manufacturing a dichroic polarizing element described in JP2002-090526A and a method of manufacturing a guest-host type liquid crystal display device described in JP2002-099388A can also be used for manufacturing the optical absorption anisotropic layer used in the optical member according to the embodiment of the present invention.

The dichroic colorant can be classified into a dichroic colorant having a rod-like molecular shape and a dichroic colorant having a disk-like molecular shape. Either may be used for manufacturing the optical absorption anisotropic layer used in the optical member according to the embodiment of the present invention.

Preferable examples of the dichroic colorant including rod-like molecules include an azo colorant, an anthraquinone colorant, a perylene colorant, and a merocyanine colorant. Examples of the azo colorant include examples described in JP1999-172252A (JP-H11-172252A), examples of the anthraquinone colorant include examples described in JP1996-067822A (JP-H8-067822A), examples of the perylene colorant include examples described in JP1987-129380A (JP-S62-129380A), and examples of the merocyanine colorant examples described in JP2002-241758A. These colorants may be used alone or in combination of two or more kinds thereof.

In addition, examples of the dichroic colorant including disk-like molecules include lyotropic liquid crystal represented by OPTIVA Inc., which is known as “E-Type polarizer”. For example, materials described in JP2002-090547A can be used.

In addition, there is also an example of using a bisazo-based dichroic colorant having a thread-like micelle type structure as a chemical structure that absorbs light in a disk shape, and materials described in JP2002-090526A can be used.

These colorants may be used alone or in combination of two or more kinds thereof.

In the case of “E-Type polarizer” using the disk-like dichroic colorant, oblique external light can be shielded without using the polarizer having an absorption axis in a main surface in combination.

Among these, as the dichroic coloring agent, a rod-like dichroic coloring agent is preferable from the viewpoint of easily obtaining a high alignment degree.

For example, the molecules of the dichroic colorant can be desirably aligned as described above in association with the alignment of host liquid crystals using the technique of the guest-host type liquid crystal cell.

Specifically, the optical absorption anisotropic layer can be manufactured by mixing the dichroic coloring agent as a guest with the rod-like liquid crystal compound as a host liquid crystal, aligning the host liquid crystal, aligning the dichroic coloring agent along the alignment of the liquid crystal molecules, and immobilizing the alignment state.

In order to prevent fluctuation of light absorbing characteristics of the optical absorption anisotropic layer depending on the use environment, it is preferable that the alignment of the dichroic colorant is immobilized by forming a chemical bond.

For example, the alignment can be immobilized by promoting polymerization of the host liquid crystals, the dichroic colorant, and an optionally added polymerizable component.

In addition, a guest-host type liquid crystal cell itself having a liquid crystal layer including at least the dichroic coloring agent and the host liquid crystal may be used as the optical absorption anisotropic layer on a pair of substrates.

The alignment of the host liquid crystal and the alignment of the dichroic coloring agent associated therewith can be controlled by an alignment film formed on an inner surface of the substrate, and the alignment state is maintained unless an external stimulus such as an electric field is applied, so that the light absorption characteristics of the optical absorption anisotropic layer can be kept constant.

In addition, by permeating the dichroic coloring agent into the polymer film and aligning the dichroic coloring agent along the alignment of the polymer molecules in the polymer film, a polymer film satisfying the light absorption characteristics required for the optical absorption anisotropic layer can be manufactured. Specifically, the polymer film can be prepared by coating a surface of the polymer film with a solution of a dichroic colorant and allowing the solution to permeate into the film.

The alignment of the dichroic colorant can be adjusted by the alignment of a polymer chain in the polymer film, the properties of the polymer chain, a coating method, and the like. The properties of the polymer chain are chemical and physical properties of the polymer chain or a functional group included in the polymer chain. The details of this method are described in JP2002-090526A.

In the present specification, the dichroic colorant (dichroic substance) is defined as a compound having a function of absorbing light.

The dichroic colorant may have any of an absorption maximum or an absorption band and preferably has an absorption maximum in any of a yellow range (Y), a magenta range (M), or a cyan range (C).

In addition, two or more kinds of dichroic colorants may be used, it is preferable that a mixture of dichroic colorants having an absorption maximum in any of Y, M, or C is used, and it is more preferable that dichroic colorants are mixed and used to absorb all the light in a visible range (400 to 750 nm).

Here, the yellow range refers to a wavelength range of 430 to 500 nm, the magenta range refers to a wavelength range of 500 to 600 nm, and the cyan range refers to a wavelength range of 600 to 750 nm.

The thickness of the optical absorption anisotropic layer is preferably 0.1 to 10 μm more preferably 0.3 to 5 μm, and still more preferably 0.5 to 3 μm. By adjusting the thickness of the optical absorption anisotropic layer to be 0.1 μm or more, diffracted light caused by oblique incidence can be sufficiently shielded. By adjusting the thickness of the optical absorption anisotropic layer to be 10 μm or less, the transmittance of external light of the front side (front external light I₀) is sufficient, and the visibility of the background can be suitably ensured.

### —Optical Absorption Anisotropic Layer Producing Method—

A method of manufacturing the optical absorption anisotropic layer is not particularly limited as long as a major axis of the dichroic colorant can be aligned to a direction perpendicular to a substrate surface (horizontal surface), and can be appropriately selected according to the purpose. Examples thereof include (1) a guest-host liquid crystal method, (2) an anodic aluminum oxide method, (3) control of the surface energy of the substrate, and (4) the use of a surfactant.

In (1) the guest-host liquid crystal method, an absorbing layer coating liquid including at least an ultraviolet-curable liquid crystal compound and a dichroic colorant is applied to a substrate including an alignment film on a surface, is dried to form a coating layer, and the coating layer is irradiated with ultraviolet light in a state of being heated to a temperature at which a liquid crystal phase is exhibited. As a result, an optical absorption anisotropic layer where a major axis of the dichroic colorant is aligned to a direction substantially perpendicular to a substrate surface is formed.

The transmittance central axis of the optical absorption anisotropic layer means a direction in which the highest transmittance is exhibited in a case where the transmittance is measured by changing the inclination angle (polar angle) and the inclination direction (azimuthal angle) with respect to the normal direction of the surface of the optical absorption anisotropic layer.

Specifically, the Mueller matrix at a wavelength of 550 nm is measured using AxoScan OPMF-2 (manufactured by Axometrics, Inc.). More specifically, in the measurement, an azimuthal angle at which the transmittance central axis is inclined is first searched for, the Mueller matrix at a wavelength of 550 nm is measured while the polar angle which is the angle with respect to the normal direction of the surface of the optical absorption anisotropic layer is changed from −70° to 70° at intervals of 1° in the surface (the plane that has the transmittance central axis and is orthogonal to the layer surface) having the normal direction of the optical absorption anisotropic layer along the azimuthal angle, and the transmittance of the optical absorption anisotropic layer is derived. As a result, the direction at which the highest transmittance is exhibited is defined as the transmittance central axis.

The transmittance central axis denotes a direction of an absorption axis (major axis direction of a molecule) of the dichroic substance contained in the optical absorption anisotropic layer.

### (Polarizer)

The optical film may include a polarizer.

The polarizer is a polarizer in which the absorption axis is present in the main surface. That is, the polarizer is a polarizer where an absorption axis is parallel to a main surface.

By including the polarizer, as described above, the optical film acts as a polarizer disposed in a crossed nicols state on the oblique external light Is such that the oblique external light Is can be suitably shielded (absorbed).

Various well-known polarizers where an absorption axis is parallel to a main surface can be used. Examples of the polarizer include an iodine-based polarizer obtained by impregnating a PVA stretched film with polyiodide ions, a dye-based polarizer obtained by impregnating a PVA stretched film with a dichroic colorant, and an optical absorption anisotropic layer having an optical performance where the absorption axis of the above-described optical absorption anisotropic layer is aligned to be parallel to the main surface.

### (Retardation Layer)

The optical film may further have a phase difference layer.

By including the retardation layer, the optical film can adjust the polarization direction of the oblique external light Is to more suitably shield the oblique external light Is. As a result, by the optical film having the phase difference layer, the visibility problem caused by the external light incident from above obliquely forward (above obliquely forward in azimuth) can be suppressed.

The optical film may further have, as necessary, a bonding layer such as a protective layer, an oxygen shielding layer, a pressure-sensitive adhesive layer, and an adhesive layer, an ultraviolet absorbing layer, and a layer that absorbs specific visible light such as a blue light absorbing layer.

### <Light Guide Member>

### (Light Guide Plate)

The light guide plate is a known light guide plate that reflects and guides (propagates) light incident into the inside.

The light guide plate is not particularly limited, and various known light guide plates used in AR glasses, a backlight unit of a liquid crystal display, and the like can be used.

### (Diffraction Element)

As the diffraction element (for example, an incidence diffraction element, an intermediate diffraction element, and an emission diffraction element) used in the optical member according to the embodiment of the present invention, a polarization diffraction element can be used.

As the polarization diffraction element, a known polarization diffraction element can be used. The polarization diffraction element is a diffraction element that controls a diffraction direction or a polarization state of emitted light, and a diffraction light intensity, by controlling a polarization state in a micro region according to a polarization state of incident light. That is, the polarization diffraction element is a diffraction element in which a diffraction efficiency changes depending on a polarization direction. Among these, as the polarization diffraction element, an element that diffracts circularly polarized light is preferable.

As the polarization diffraction element, various known diffraction elements such as a diffraction element in which a diffraction structure is formed using structural birefringence of a relief type diffraction element and a volume hologram diffraction element, and a liquid crystal diffraction element can be used. Examples of a suitable example of the liquid crystal diffraction element include a liquid crystal diffraction element that is formed of a composition containing a liquid crystal compound and has a liquid crystal alignment pattern in which an orientation of an optical axis derived from the liquid crystal compound changes while continuously rotating along at least one in-plane direction. In addition, examples of another suitable example of the liquid crystal diffraction element include a diffraction element having a cholesteric liquid crystal layer formed by immobilizing a cholesteric liquid crystal phase.

Among these, as the diffraction element in which the diffraction efficiency changes depending on the polarization direction, a liquid crystal diffraction element is preferable. As the liquid crystal diffraction element, for example, liquid crystal diffraction elements described in paragraphs 0070 to 0143 of WO2021/106749A can also be preferably used.

In the present specification, the slit direction is a direction of a structure that causes diffraction in a diffraction element (diffraction grating). Examples of the structure that generates diffraction include a groove, a protrusion, a boundary between different liquid crystal alignment structures, a boundary between different refractive indices, and a boundary between different transmittances.

Specifically, in a case where the diffraction element is a diffraction element having a physical groove shape, for example, a surface relief type diffraction element or a holographic surface diffraction element, an extending direction (longitudinal direction) of the groove portion that forms the diffraction element is the slit direction.

In a case where the diffraction element is a diffraction element having a high refractive index region and a low refractive index region as in a transmissive volume phase holographic diffraction element, an extending direction of a boundary between the high refractive index region and the low refractive index region is the slit direction.

In a case where the diffraction element is a liquid crystal diffraction element, a direction in which an alignment direction of a liquid crystal compound is uniform in any plane of a thickness direction of the diffraction element is the slit direction. For example, as described in FIG. 7 of WO2021/106749A, in a liquid crystal diffraction element having a liquid crystal alignment pattern in which a liquid crystal compound 40 continuously rotates in an arrow X direction, a Y direction in which an alignment direction of the liquid crystal compound 40 is uniform in a direction orthogonal to the arrow X direction is the slit direction.

The external light obliquely incident on the diffraction element of the AR glasses is often the external light incident on the AR glasses from above (particularly, above the front), such as sunlight and indoor illumination light. That is, in a case where the external light is diffracted by the diffraction element and reaches an observation position of the user, a visibility problem is likely to occur.

Here, the diffraction element in which the slit direction is close to the horizontal direction easily diffracts the external light incident from above (particularly, above the front) in the direction of the observation position of the user by transmitting the light guide plate. Therefore, in a case where the optical member according to the embodiment of the present invention has a plurality of diffraction elements, it is preferable to provide the optical film in at least the diffraction element in which the slit direction is closest to the horizontal direction.

### [Image Display Device]

The first to third optical members are preferably applied to a head-mounted display (for example, an image display device such as AR glasses), and more preferably applied to AR glasses.

The image display device according to the embodiment of the present invention is typically configured to comprise the above-described optical member (any one of the first to third optical members) and a display element that emits an image to an incidence diffraction element in the optical member. The display element displays an image (video) to be observed by the user U and emits the image to the incidence diffraction element. Accordingly, the display elements are disposed such that the emitted image is incident into the incidence diffraction element.

Hereinafter, various members of the image display device will be described.

### <Optical Member>

As the optical member, any one of the first to third optical members described above can be used.

### <Display Element>

The type of the display element is not particularly limited, and various known display elements (display devices, projectors) used in AR glasses and the like can be used. Examples of the display element include a display element including a display and a projection lens.

In the image display device, the display is not particularly limited, and various known displays used in AR glasses and the like can be used.

Examples of the display include a liquid crystal display (including Liquid Crystal On Silicon (LCOS)), an organic electroluminescent display, and a scanning type display employing a digital light processing (DLP) or Micro Electro Mechanical Systems (MEMS) mirror.

In a case where the image display device displays a polychromic image, a display that displays a polychromic image is used. In addition, in a case where the image display device has a plurality of optical members, a display that displays a multicolor image using light having a wavelength diffracted by each diffraction element of each optical member is used.

In the display element, a known projection lens (collimating lens) used in AR glasses and the like can also be used as the projection lens.

The display image (that is, the light emitted by the display element) displayed by the display element is not particularly limited, but is preferably unpolarized light (natural light) or circularly polarized light.

In a case where the display element emits circularly polarized light and the display emits an unpolarized light image, it is preferable that the display element includes, for example, a circularly polarizing plate consisting of a linear polarizer and a λ/4 plate. In addition, in a case where the display emits a linearly polarized light image, it is preferable that the display element includes, for example, a λ/4 plate. The light to be emitted by the display element may be another polarized light (for example, linearly polarized light).

### EXAMPLES

Hereinafter, the present invention will be described in more detail based on Examples.

The materials, the amounts and proportions of the materials used, the details of treatments, the procedure of treatments, and the like shown in the following Examples can be appropriately modified as long as the gist of the present invention is maintained. Therefore, the scope of the present invention is not restricted by the following examples.

### Example 1 (Production of Optical Member A1)

An optical member A1 of Example 1 was produced by the following procedure. The optical member A1 corresponds to the first optical member described in the upper part.

### [Preparation of Optical Absorption Anisotropic Layer 1]

The optical absorption anisotropic layer 1 was produced by the following procedure.

### <Formation of Alignment Film Layer>

The following composition 1 for forming an alignment film was applied onto a surface of a commercially available cellulose acylate film (manufactured by FUJIFILM Corporation, trade name: FUJITAC TG60UL) using a wire bar. The support on which the coating film was formed was dried with hot air at 140° C. for 120 seconds to form an alignment film AL1, thereby obtaining a cellulose acylate film 1 with an alignment film. A film thickness of the alignment film AL1 was 1 μm.

Composition 1 for forming alignment film

| | |
|---|---|
| Polymer PA-1 shown below | 100.00 parts by mass |
| Acid generator PAG-1 shown below | 8.25 parts by mass |
| Stabilizer DIPEA shown below | 0.6 parts by mass |
| Butyl acetate | 1001.42 parts by mass |
| Methyl ethyl ketone | 250.36 parts by mass |

Polymer PA-1 (in the formulae, the numerical value described in each repeating unit denotes the content (% by mass) of each repeating unit with respect to all repeating units) 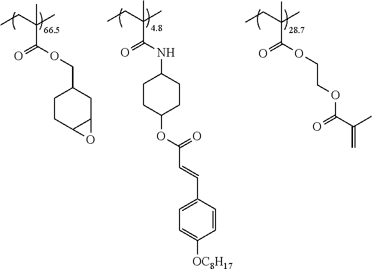
Acid generator PAG-1 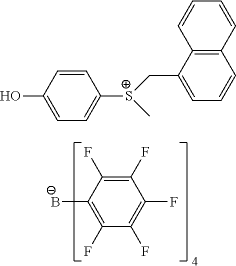
Stabilizer DIPEA

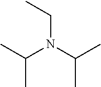

### <Formation of Optical Absorption Anisotropic Layer 1>

The obtained cellulose acylate film 1 with an alignment film was continuously coated with the following composition P1 for forming an optical absorption anisotropic layer using a wire bar, heated at 120° C. for 60 seconds, and cooled to room temperature (23° C.).

Next, the coating layer was heated at 85° C. for 60 seconds, and then cooled to room temperature again.

Thereafter, the coating layer was irradiated from a normal direction to the film with light for 2 seconds under an irradiation condition of illuminance of 200 mW/cm² using an LED lamp (central wavelength: 365 nm) to produce an optical absorption anisotropic layer 1 on the alignment film AL1. A film thickness of the optical absorption anisotropic layer 1 was 4.5 μm.

Hereinafter, the film comprising the optical absorption anisotropic layer 1 produced above is also referred to as an “optical absorption anisotropic film 1”.

### <Measurement of Transmittance Central Axis of Optical Absorption Anisotropic Layer 1>

The optical absorption anisotropic film 1 produced in the upper part was installed on a sample stage in the horizontal direction, and the transmittance was measured while variously changing the azimuthal angle and the polar angle at which the light was incident on the film using AxoScan OPMF-2 (manufactured by Axometrics, Inc.) as described above, and the azimuthal angle and the polar angle of the transmittance central axis of the optical absorption anisotropic layer 1 were examined. The transmittance central axis of the optical absorption anisotropic layer 1 was in a polar angle 0° direction.

Composition P1 for forming optical absorption anisotropic layer

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 shown below mass | 8.67 parts by mass |
| Liquid crystal compound L-1 shown below | 1.97 parts by mass |
| IRGACURE OXE-02 (manufactured by BASF SE) mass | 0.20 parts by mass |
| Alignment agent E-1 shown below | 0.16 parts by mass |
| Alignment agent E-2 shown below | 0.16 parts by mass |
| Surfactant F-2 shown below | 0.007 parts by mass |
| Cyclopentanone | 78.17 parts by mass |
| Benzyl alcohol | 8.69 parts by mass |

Dichroic substance D-1 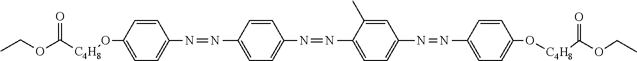
Dichroic substance D-2 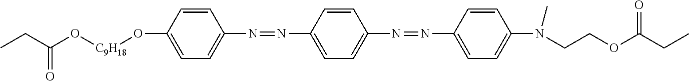
Dichroic substance D-3 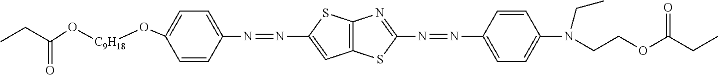
Polymer liquid crystal compound P-1 (in the formula, numerical values described in each repeating unit in the main chain represent a content (% by mass) of each repeating unit with respect to all repeating units) 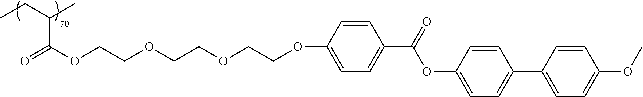 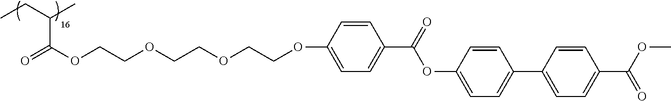 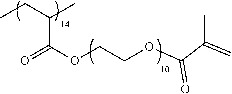
Liquid crystal compound L-1 [mixture of the following liquid crystal compounds (RA), (RB), and (RC) at a ratio of 84:14:2 (mass ratio) 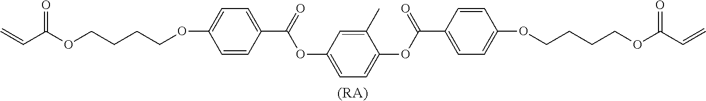 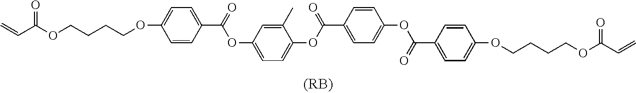 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 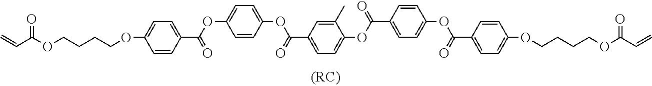 [SMILES: C=CC(=O)OCCCCOc1ccc(C(=O)Oc2ccc(OC(=O)c3ccc(OC(=O)c4ccc(OC(=O)c5ccc(OCCCCOC(=O)C=C)cc5)cc4)c(C)c3)cc2)cc1]
Alignment agent E-1 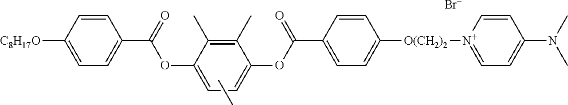
Alignment agent E-2 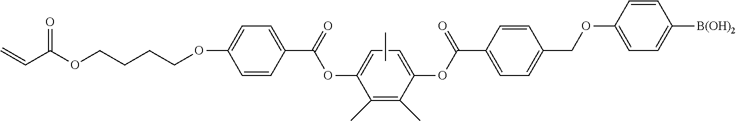
Surfactant F-2 (in the formulae, the numerical value described in each repeating unit denotes the content (% by mass) of each repeating unit with respect to all repeating units)

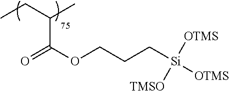

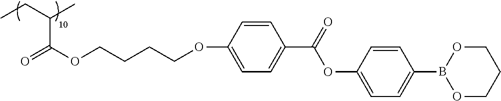

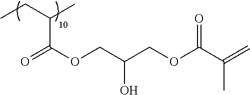

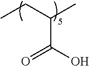

TMS represents a trimethylsilyl group.

[Formation of Protective Layer b1]

A coating film was formed by continuously coating the obtained optical absorption anisotropic layer 1 with the following composition B1 for forming a protective layer using a wire bar.

Next, the support on which the coating film was formed was dried with hot air at 60° C. for 60 seconds and further dried with hot air at 100° C. for 120 seconds to form a protective layer B1. A film thickness of the protective layer B1 was 0.5 μm.

By the above procedure, a laminate 1 having a configuration of the cellulose acylate film 1 with the alignment film/optical absorption anisotropic layer 1/protective layer B1 was obtained.

Composition B1 for forming protective layer

| | |
|---|---|
| Modified polyvinyl alcohol PVA-1 shown below | 3.80 parts by mass |
| Omnirad 2959 (IGM Resins B.V.) 0.20 parts by | 0.20 parts by mass |
| mass | |
| Coloring agent compound G-1 shown below | 0.08 parts by mass |
| Water | 70 parts by mass |
| Methanol | 30 parts by mass |

Modified polyvinyl alcohol PVA-1 (in the formulae, the numerical value described in each repeating unit represents a content (% by mass) of each repeating unit with respect to all repeating units) 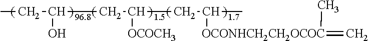
Coloring agent compound G-1

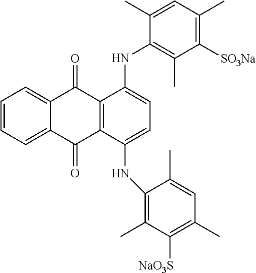

### [Preparation of λ/4 Film]

### [Synthesis of Polymer P-1]

The polymer P-1 was synthesized using the monomer mA-1 and the monomer mB-1 as raw material monomers.

<Synthesis of Monomer mA-1>

4-aminocyclohexanol (50.0 g), triethylamine (48.3 g), and N,N-dimethylacetamide (800 g) were weighed in a 2 L three-neck flask comprising a stirring blade, a thermometer, a dropping funnel, and a reflux pipe, and were stirred under ice cooling.

Next, methacrylic acid chloride (47.5 g) was added dropwise to the above-described flask over 40 minutes using the dropping funnel, and after completion of the dropwise addition, the reaction solution was stirred at 40° C. for 2 hours.

The reaction solution was cooled to room temperature (23° C.), and was filtered under reduced pressure to remove the precipitated salt. The obtained organic layer was transferred to a 2 L three-neck flask comprising a stirring blade, a thermometer, a dropping funnel, and a reflux pipe, and stirred under ice cooling.

Next, N,N-dimethylaminopyridine (10.6 g) and triethylamine (65.9 g) were added to the flask, and 4-n-octyloxy cinnamic acid chloride (127.9 g) dissolved previously in tetrahydrofuran (125 g) was added dropwise to the flask using the dropping funnel over 30 minutes. After completion of the dropwise addition, the reaction solution was stirred at 50° C. for 6 hours. The reaction solution was cooled to room temperature, separation and washing were performed with water, the obtained organic layer was dried with anhydrous magnesium sulfate, and the obtained solution was concentrated to obtain a yellowish white solid.

The obtained yellowish white solid was heated and dissolved in methyl ethyl ketone (400 g) to be recrystallized. As a result, 76 g of a monomer mA-1 shown below was obtained as a white solid (yield: 40%).

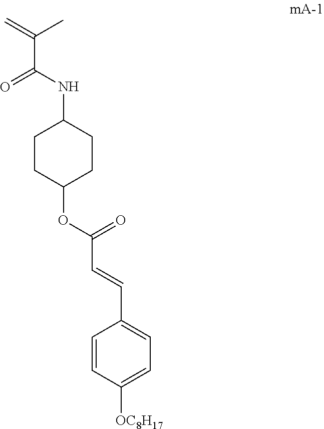

<Monomer mB-1>

As the monomer mB-1, CYCLOMER M-100 (manufactured by Daicel Corporation) having the following structure was used.

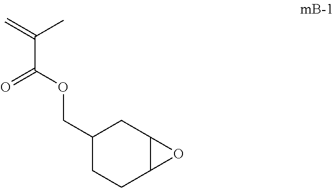

### <Synthesis of Polymer P-1>

A flask comprising a cooling pipe, a thermometer, and a stirrer was charged with 2-butanone (5 parts by mass) as a solvent, and while flowing nitrogen in the flask at 5 mL/min, the solvent was refluxed by heating in a water bath. A solution obtained by mixing the monomer mA-1 (1.2 parts by mass), the monomer mB-1 (8.8 parts by mass), 2,2′-azobis(isobutyronitrile) (1 part by mass) as a polymerization initiator, and 2-butanone (5 parts by mass) as a solvent was added dropwise thereto over 3 hours, and the obtained reaction solution was stirred while maintaining the reflux state for 3 hours. After completion of the reaction, the reaction solution was allowed to cool to room temperature, and 2-butanone (30 parts by mass) was added to the reaction solution for dilution to obtain a polymer solution having a polymer concentration of approximately 20% by mass. The obtained polymer solution was poured into a large excess of methanol to precipitate the polymer, the precipitate was separated by filtration, and the obtained solid content was washed with a large amount of methanol, and then subjected to blast drying at 50° C. for 12 hours, thereby obtaining a polymer P-1 having a photo-aligned group.

### [Preparation of λ/4 Film]

### <Preparation of Composition for Forming Photo-Alignment Film>

A composition 3 for forming a photo-alignment film was prepared as follows.

Composition 3 for forming photo-alignment film

| | |
|---|---|
| Polymer P-1 described above | 100.00 parts by mass |
| Thermal acid generator D-1 shown below | 3.00 parts by mass |
| Diisopropylethylamine | 0.60 parts by mass |
| Butyl acetate | 953.12 parts by mass |
| Methyl ethyl ketone | 238.28 parts by mass |

Thermal acid generator D-1

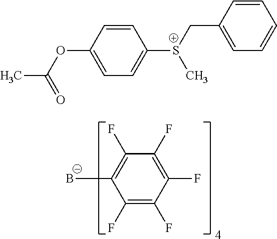

The prepared composition 3 for forming a photo-alignment film was sealed in a glass bottle, and stored at normal temperature in a sealed state for 7 days.

### <Formation of 24 Layer>

One surface of a cellulose acylate film (TAC base material; manufactured by FUJIFILM Corporation, TG40) having a thickness of 40 μm was coated with the composition 3 for forming a photo-alignment film, which had been stored for 7 days, using a bar coater. Next, the film to which the composition 3 for forming a photo-alignment film was applied was dried on a hot plate at 125° C. for 2 minutes to remove the solvent, and a precursor film having a thickness of 0.15 μm was formed. The obtained precursor film was irradiated with polarized ultraviolet rays (8 mJ/cm², using an ultra-high pressure mercury lamp) to form a photo-alignment film 3.

Next, the photo-alignment film 3 was coated with the following coating liquid B for a retardation layer using a bar coater. The coating film formed on the photo-alignment film 3 was heated to 120° C. with hot air and cooled to 60° C. Then, the coating film was irradiated with ultraviolet rays of 100 mJ/cm² at a wavelength of 365 nm using a high-pressure mercury lamp under a nitrogen atmosphere, and further irradiated with ultraviolet rays of 500 mJ/cm² while being heated to 120° C. By the above procedure, the alignment of the liquid crystal compound was immobilized to produce a λ/4 layer. Re(550) of the obtained laminate (cellulose acylate film/photo-alignment film 3/λ/4 layer) was 140 nm, and Rth(550) was 80 nm, and the laminate was a λ/4 film.

Coating liquid B for retardation layer

| | |
|---|---|
| Polymerizable liquid crystal compound L-1 shown below mass | 39.00 parts by mass |
| Polymerizable liquid crystal compound L-2 shown below mass | 39.00 parts by mass |
| Polymerizable liquid crystal compound L-3 shown below mass | 17.00 parts by mass |
| Polymerizable liquid crystal compound A-1 shown below mass | 5.00 parts by mass |
| Polymerization initiator S-1 (oxime type) shown below | 0.50 parts by mass |
| Surfactant F-3 shown below | 0.20 parts by mass |
| Cyclopentanone | 235.00 parts by mass |

Polymerizable Liquid Crystal Compound L-1 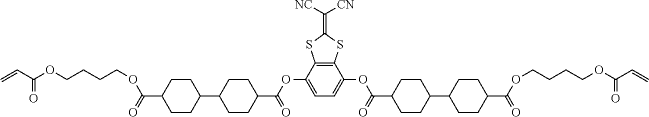 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Polymerizable Liquid Crystal Compound L-2 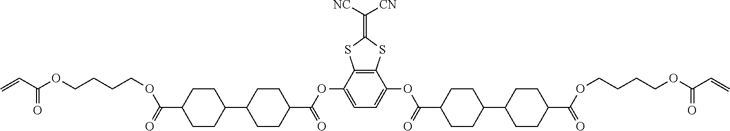 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Polymerizable Liquid Crystal Compound L-3 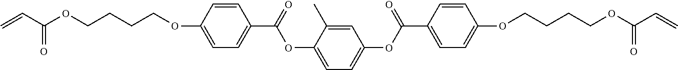 [SMILES: C=CC(=O)OCCCCOc1ccc(C(=O)Oc2ccc(OC(=O)c3ccc(OCCCCOC(=O)C=C)cc3)c(C)c2)cc1]
Polymerizable Liquid Crystal Compound A-1 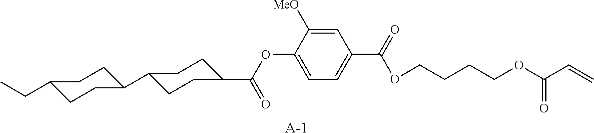
Polymerization initiator S-1 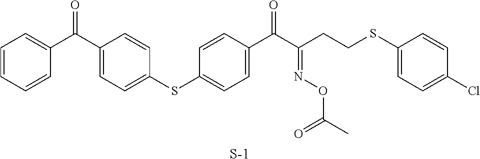
Surfactant F-3 (in the formula, numerical values added to each repeating unit in the main chain represent a content (% by mass) of each repeating unit with respect to all repeating units)

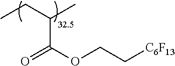

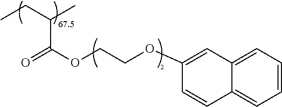

### [Production of Optical Film 1]

The surface of the protective layer B1 formed in the laminate 1 produced in the upper part and the surface of the λ/4 layer of the λ/4 film described above were bonded to each other using a commercially available pressure-sensitive adhesive (SK2057, manufactured by Soken Chemical & Engineering Co., Ltd.), and then the cellulose acylate film (TG40, manufactured by FUJIFILM Corporation) as a support member of the λ/4 layer in the obtained bonded material was peeled off between the cellulose acylate film and the photo-alignment film to produce an optical film 1.

### (Measurement of Transmittance and Circular Polarization Degree)

The transmittance and the circular polarization degree of the optical film 1 produced in the upper part were measured by actually measuring a Mueller matrix at a wavelength of 550 nm using AxoScan OPMF-2 (manufactured by Axometrics, Inc.). Specifically, the optical absorption anisotropic layer was irradiated with light from the optical absorption anisotropic layer side and measured at measurement angle conditions in which the polar angle was 0°, 30°, and 60° and the azimuthal angle was 5° intervals using the measurement mode “Arbitrary Field-of-View” of AxoScan. The results are shown in Table 1. In addition, it was found that the light incident in the polar angle 60° direction was left circularly polarized light.

[Production of Light Guide Plate (Light Guide Member) on which Liquid Crystal Diffraction Element is Disposed]

A light guide plate (light guide member) on which the liquid crystal diffraction element was disposed was produced in the same manner as in Comparative Example 5 described in WO2021/106749A. It was confirmed that the liquid crystal diffraction element produced was diffracted by irradiation with right circularly polarized light.

### [Production of Optical Member A1]

The optical film 1 produced in the upper part and the light guide member produced in the upper part were superimposed on each other to produce an optical member A1. In this case, in a case where the optical member A1 was in a used state, the optical film 1 was disposed such that the angle between the slow axis (in-plane slow axis) of the λ/4 film included in the optical film 1 and the horizontal direction was 10°.

The layer configuration of the optical member A1 was in the order of “optical absorption anisotropic layer 1/λ/4 film/light guide member” as shown in the table. The optical film 1 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Example 2 (Production of Optical Member A2)

### [Production of Optical Film 2]

An optical member A2 of Example 2 was produced by the following procedure. The optical member A2 corresponds to the second optical member described in the upper part.

The surface of the protective layer B1 formed in the laminate 1 produced in the upper part and the surface of the λ/4 layer of the λ/4 film described above were bonded to each other using a commercially available pressure-sensitive adhesive (SK2057, manufactured by Soken Chemical & Engineering Co., Ltd.), and then the cellulose acylate film (TG40, manufactured by FUJIFILM Corporation) as a support member of the λ/4 layer in the obtained bonded material was peeled off between the cellulose acylate film and the photo-alignment film. Further, the λ/4 layer of the λ/4 film prepared separately was bonded to each other using a commercially available pressure-sensitive adhesive (SK2057, manufactured by Soken Chemical & Engineering Co., Ltd.). In this case, the two λ/4 layers were bonded to each other such that the angle formed by the slow axes of the two λ/4 layers was 45°. Next, the cellulose acylate film (TG40, manufactured by FUJIFILM Corporation) as a support member of the λ/4 layer was peeled off from the λ/4 film in the obtained bonded material between the cellulose acylate film and the photo-alignment film to produce an optical film 2.

The transmittance and the circular polarization degree were measured in the same manner as in Example 1. The results are shown in Table 1.

### [Production of Optical Member A2]

The optical film 2 produced in the upper part and the light guide member produced in the upper part were superimposed on each other to produce an optical member A2. In this case, in a case where the optical member A2 was in a used state, the optical film 2 was disposed such that the slow axis (in-plane slow axis) of the λ/4 film on the light guide plate side included in the optical film 2 and the horizontal direction were parallel (the angle between the in-plane slow axis and the horizontal direction was) 0°.

The layer configuration of the optical member A2 was in the order of “optical absorption anisotropic layer 1/λ/4 film/λ/4 film/light guide member” as shown in the table. In addition, the optical film 2 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Example 3 (Production of Optical Member A3)

An optical member A3 of Example 3 was produced by the following procedure. The optical member A3 corresponds to the second optical member described in the upper part.

### [Preparation of λ/4 Film 2]

### <Extrusion Molding>

A cycloolefin resin (ARTON G7810, manufactured by JSR Corporation) was dried at 100° C. for 2 hours or longer, and melt-extruded at 280° C. using a twin screw kneading extruder. Here, a screen filter, a gear pump, and a leaf disc filter were arranged in this order between the extruder and a die, these were connected by a melt pipe, and the resultant was extruded from a T die having a width of 1000 mm and a lip gap of 1 mm and was cast on a triple cast roll in which temperatures were set to 180° C., 175° C., and 170° C., thereby obtaining an unstretched film 1 having a width of 900 mm and a thickness of 325 μm.

### <Stretching and Thermal Fixing>

A stretching step and a thermal fixation step were performed using the following method on the unstretched film 1 that was being transported.

### (a) Machine-Direction Stretching

The unstretched film 1 was stretched in the machine direction under the following conditions while being transported using an inter-roll machine-direction stretching machine having an aspect ratio (L/W) of 0.2.

### —Conditions—

Preheating temperature: 175° C.
Stretching temperature: 175° C.
Stretching ratio: 24%

### (b) Cross-Direction Stretching

The film that was stretched in the machine direction was stretched in the cross-direction under the following conditions while being transported using a tenter.

### —Conditions—

Preheating temperature: 180° C.
Stretching temperature: 180° C.
Stretching ratio: 140%

### (c) Thermal Fixation

After the stretching step, a heating treatment was performed on the stretched film under the following conditions while end portions of the stretched film were gripped with a tenter clip to hold both end portions of the stretched film such that the width thereof was constant (within 3% of expansion or contraction), and the stretched film was thermally fixed.
Thermal fixation temperature: 165° C.
Thermal fixation time: 30 seconds

The preheating temperature, the stretching temperature, and the thermal fixation temperature are average values of values measured at five points in the width direction using a radiation thermometer.

### <Winding>

After the thermal fixation, both ends were trimmed, and the film was wound at a tension of 25 kg/m to obtain a film roll of a stretched film having a width of 1340 mm and a winding length of 2000 m.

Re of the obtained stretched film was 140 nm, and Rth was 125 nm. The stretched film obtained by the above procedure was used as a λ/4 film 2.

### [Preparation of Optical Film 3]

An optical member A3 of Example 3 was produced by the following procedure. The optical member A3 corresponds to the second optical member described in the upper part.

The surface of the protective layer B1 formed in the laminate 1 produced in the upper part and the λ/4 film 2 described above were bonded to each other using a commercially available pressure-sensitive adhesive (SK2057, manufactured by Soken Chemical & Engineering Co., Ltd.). Further, the λ/4 film 2 prepared separately was bonded to the already bonded λ/4 film 2 side using a commercially available pressure-sensitive adhesive (SK2057, manufactured by Soken Chemical & Engineering Co., Ltd.). In this case, the two λ/4 films 2 were bonded to each other such that the angle formed by the slow axes of the two λ/4 films 2 was 45°, thereby producing an optical film 3.

The transmittance and the circular polarization degree were measured in the same manner as in Example 1. The results are shown in Table 1.

### [Production of Optical Member A3]

An optical member A3 was produced in the same manner as in the optical member A2 in the production of the optical member A2 of Example 2, except that the optical film 2 was changed to the optical film 3.

### Example 4 (Production of Optical Member A4)

An optical member A4 of Example 4 was produced by the following procedure. The optical member A4 corresponds to the second optical member described in the upper part.

### (Preparation of C-Plate 1)

A composition for forming a C-plate 1 shown below was prepared to obtain a uniform solution.

Composition for forming C-plate 1

| | |
|---|---|
| Discotic liquid crystal compound CA-1 shown below | 80 parts by mass |
| Discotic liquid crystal compound CA-2 shown below | 20 parts by mass |
| Discotic liquid crystal compound CB-1 shown below | 5.6 parts by mass |
| Polymerizable monomer CS1 shown below: | 5.6 parts by mass |
| Polymer CC-1 shown below: | 0.2 parts by mass |
| Polymerization initiator (IRGACURE 907, manufactured by BASF SE) | 3 parts by mass |
| Toluene | 170 parts by mass |
| Methyl ethyl ketone | 73 parts by mass |

Discotic liquid crystal compound CA-1 (1,3,5-substituted benzene type polymerizable discotic liquid crystal compound) 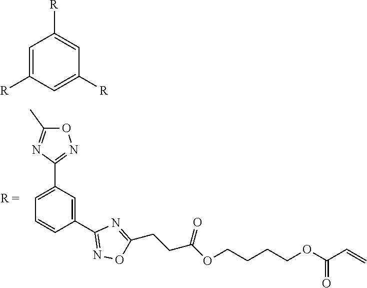
Discotic liquid crystal compound CA-2 (1,3,5-substituted benzene type polymerizable discotic liquid crystal compound) 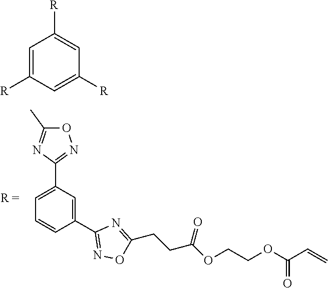
Discotic liquid crystal compound CB-1 (polymerizable triphenylene type discotic liquid crystal compound) 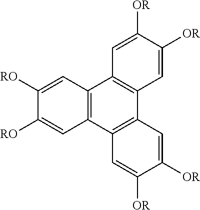 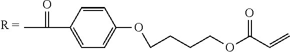 [SMILES: C=CC(=O)OCCCCOc1ccc(C(C)=O)cc1]
Polymerizable monomer CS1 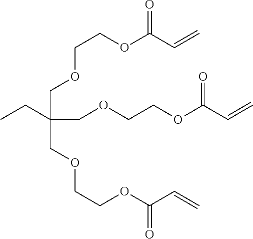 [SMILES: C=CC(=O)OCCOCC(CC)(COCCOC(=O)C=C)COCCOC(=O)C=C]
Polymer CC-1 (hereinafter, the copolymerization ratio of the chemical structural formula is in units of % by mass)

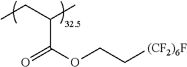

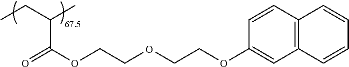

As a support, a commercially available cellulose triacetate film (Fujitac ZRD40, manufactured by FUJIFILM Corporation) was saponified and used. The surface of the support was coated with the composition for forming a C-plate 1, and the solvent was dried in a step of continuously heating the coating film from room temperature to 100° C., and the coating film was further heated at 100° C. for about 90 seconds in a drying zone. Thereafter, the coating film was cooled to 60° C. and then exposed to UV rays at 300 mJ/cm² in the air to cure the coating film to form a cured film. After the cured film was allowed to cool to room temperature, the alignment state of the cured film was observed, and it was found that the discotic liquid crystal compound was horizontally aligned without defects.

Re of the laminate of the obtained cured film and the support was 3 nm, and Rth was 180 nm. The above-described laminate was used as a C-plate 1.

### [Production of Optical Film 4]

The surface of the protective layer B1 formed in the laminate 1 produced in the upper part and the surface of the λ/4 layer of the λ/4 film described above were bonded to each other using a commercially available pressure-sensitive adhesive (SK2057, manufactured by Soken Chemical & Engineering Co., Ltd.), and then the cellulose acylate film (TG40, manufactured by FUJIFILM Corporation) as a support member of the λ/4 layer in the obtained bonded material was peeled off between the cellulose acylate film and the photo-alignment film, and the peeled surface and the C-plate 1 were bonded to each other using an adhesive (SK2057, manufactured by Soken Chemical & Engineering Co., Ltd.).

Next, the surface of the λ/4 film on which the λ/4 layer was formed, which was prepared separately, and the already bonded C-plate 1 were bonded to each other using a commercially available pressure-sensitive adhesive (SK2057, manufactured by Soken Chemical & Engineering Co., Ltd.). In this case, the two bonded λ/4 layers were bonded to each other such that the angle formed by the slow axes of the two λ/4 layers was 45°. Next, the cellulose acylate film (TG40, manufactured by FUJIFILM Corporation) as a support member of the λ/4 layer was peeled off from the λ/4 film in the obtained bonded material between the cellulose acylate film and the photo-alignment film to produce an optical film 4.

The transmittance and the circular polarization degree were measured in the same manner as in Example 1. The results are shown in Table 1.

### [Production of Optical Member A4]

The optical film 4 produced in the upper part and the light guide member produced in the upper part were superimposed on each other to produce an optical member A4. In this case, in a case where the optical member A4 was in a used state, the optical film 4 was disposed such that the slow axis (in-plane slow axis) of the λ/4 film on the light guide plate side included in the optical film 4 and the horizontal direction were parallel (the angle between the in-plane slow axis and the horizontal direction was 0°).

The layer configuration of the optical member A4 was in the order of “optical absorption anisotropic layer 1/λ/4 film/C-plate/λ/4 film/light guide member” as shown in the table. In addition, the optical film 4 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Example 5 (Production of Optical Member A5)

An optical member A5 of Example 5 was produced by the following procedure. The optical member A5 corresponds to the third optical member described in the upper part.

### [Production of Twist Film 1]

A surface of a PET film (manufactured by FUJIFILM Corporation) having a thickness of 75 μm was rubbed to prepare a peelable support.

The following coating liquid 1 for a twist layer was applied onto the rubbing-treated surface of the produced peelable support using a bar coater such that the film thickness of the coating film to be obtained was 3.4 μm, thereby forming a coating film.

Next, the coating film was heated and aged at a coating film surface temperature of 60° C. for 90 seconds, and then irradiated with ultraviolet rays at 300 mJ/cm² at 100° C. to immobilize the alignment of the liquid crystal compound, thereby forming a twist layer, thereby producing a twist film 1 including the peelable support and the twist layer.

As a result of confirmation by analysis using AxoScan OPMF-2 (manufactured by Axometrics, Inc.), in the obtained twist layer, And of the liquid crystal compound was 550 nm. In addition, the twist layer contained a liquid crystal compound twisted and aligned along a helical axis extending in the thickness direction. In a case where a twisted angle of a helical liquid crystal compound was checked by analysis using AxoScan OPMF-2 (manufactured by Axometrics, Inc.), the twisted angle was 255°.

Coating liquid 1 for twisted layer

| | |
|---|---|
| Methyl ethyl ketone | 233 parts by mass |
| Cyclohexanone | 12 parts by mass |
| Rod-like liquid crystal compound 201 shown below | 83 parts by mass |
| Rod-like liquid crystal compound 202 shown below | 15 parts by mass |
| Rod-like liquid crystal compound 203 shown below | 2 parts by mass |
| Polyfunctional monomer A-TMMT (manufactured by Shin-Nakamura Chemical Co., Ltd.) | 1 part by mass |
| Omnirad 819 (manufactured by IGM Resins B.V.) | 4 parts by mass |
| Surfactant 1 shown below | 0.04 parts by mass |
| Surfactant 2 shown below | 0.01 parts by mass |
| Chiral agent 1 shown below | 0.511 parts by mass |

ROD-LIKE LIQUID CRYSTAL COMPOUND 201 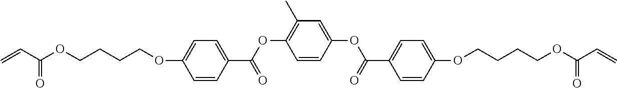 [SMILES: C=CC(=O)OCCCCOc1ccc(C(=O)Oc2ccc(OC(=O)c3ccc(OCCCCOC(=O)C=C)cc3)c(C)c2)cc1]
ROD-LIKE LIQUID CRYSTAL COMPOUND 202 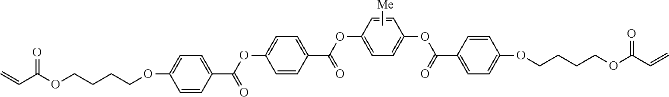
ROD-LIKE LIQUID CRYSTAL COMPOUND 203 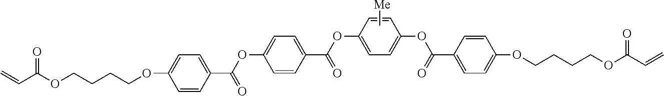
SURFACTANT 1 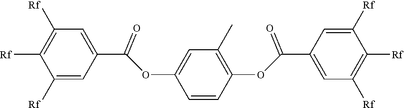 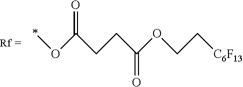
SURFACTANT 2 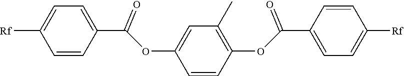 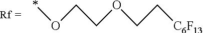
Chiral agent 1

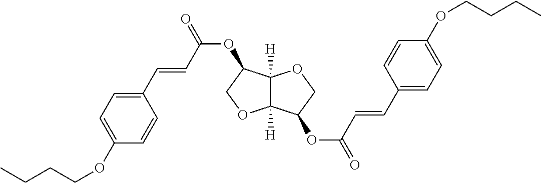 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

### [Production of Optical Film 5]

The surface of the protective layer B1 formed in the laminate 1 produced in the upper part and the surface of the twist film 1 on which the twist layer was formed were bonded to each other using a commercially available pressure-sensitive adhesive (SK2057, manufactured by Soken Chemical & Engineering Co., Ltd.), and then the peelable support of the twist film 1 was peeled off to produce an optical film 5.

The transmittance and the circular polarization degree were measured in the same manner as in Example 1. The results are shown in Table 2.

### [Production of Optical Member A5]

The optical film 5 produced in the upper part and the light guide member produced in the upper part were superimposed on each other to produce an optical member A5. In this case, in a case where the optical member A5 was in a used state, the optical film 5 was disposed such that the angle between the slow axis (in-plane slow axis) of the twist layer on the optical absorption anisotropic layer 1 side included in the optical film 5 and the horizontal direction was 25°.

The layer configuration of the optical member A5 was in the order of “optical absorption anisotropic layer 1/twist film 1/light guide member” as shown in the table. In addition, the optical film 5 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Example 6 (Production of Optical Member A6)

An optical member A6 of Example 6 was produced by the following procedure. The optical member A6 corresponds to the third optical member described in the upper part.

### [Production of Twist Film 2]

A twist film 2 was produced in the same manner as in the production of the twist film 1, except that the coating liquid 1 for a twist layer was changed to the following coating liquid 2 for a twist layer in the production of the twist film 1. In this case, the film thickness of the obtained twist layer was 3.1 μm, and Δnd was 550 nm. In addition, the twisted angle of the helical liquid crystal compound of the twist layer was 315°.

Coating liquid 2 for twist layer

| | | |
|---|---|---|
| Methyl ethyl ketone | 233 | parts by mass |
| Cyclohexanone | 12 | parts by mass |
| Rod-like liquid crystal compound 201 shown | 83 | parts by mass |
| above | | |
| Rod-like liquid crystal compound 202 shown | 15 | parts by mass |
| above | | |
| Rod-like liquid crystal compound 203 shown | 2 | parts by mass |
| above | | |
| Polyfunctional monomer A-TMMT | 1 | part by mass |
| (manufactured by Shin-Nakamura | | |
| Chemical Co., Ltd.) | | |
| Omnirad 819 (manufactured by IGM Resins | 4 | parts by mass |
| B.V.) | | |
| Surfactant 1 shown above | 0.05 | parts by mass |
| Surfactant 2 shown above | 0.01 | parts by mass |
| Chiral agent shown above | 0.694 | parts by mass |

### (Preparation of C-Plate 2)

A C-plate 2 was produced in the same manner as in the production of the C-plate 1, except that the coating amount of the composition for forming a C-plate 1 was adjusted to change Rth to 200 nm in the production of the plate 1.

### [Production of Optical Film 6]

The surface of the protective layer B1 formed in the laminate 1 produced in the upper part and the surface of the twist film 2 on which the twist layer was formed were bonded to each other using a commercially available pressure-sensitive adhesive (SK2057, manufactured by Soken Chemical & Engineering Co., Ltd.), and then the peelable support of the twist film 2 was peeled off. Next, the peeled surface and the coating surface of the C-plate 2 were bonded to each other using a commercially available pressure-sensitive adhesive (SK2057, manufactured by Soken Chemical & Engineering Co., Ltd.) to produce an optical film 6.

The transmittance and the circular polarization degree were measured in the same manner as in Example 1. The results are shown in Table 2.

### [Production of Optical Member A6]

The optical film 6 produced in the upper part and the light guide member produced in the upper part were superimposed on each other to produce an optical member A6. In this case, in a case where the optical member A6 was in a used state, the optical film 6 was disposed such that the angle between the slow axis (in-plane slow axis) of the twist layer on the optical absorption anisotropic layer 1 side included in the optical film 6 and the horizontal direction was 20°.

The layer configuration of the optical member A6 was in the order of “optical absorption anisotropic layer 1/twist film 2/C-plate 2/light guide member” as shown in the table. In addition, the optical film 6 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Comparative Example 1 (Production of Optical Member B1)

### (Production of Optical Film B1)

The above-described laminate 1 was used as an optical film B1.

The transmittance and the circular polarization degree were measured in the same manner as in Example 1. The results are shown in Table 3.

### [Production of Optical Member B1]

The above-described optical film B1 and the above-described light guide member were superimposed on each other to produce an optical member B1. The layer configuration of the optical member B1 was in the order of “optical absorption anisotropic layer 1/light guide member” as shown in the table. In addition, the optical film B1 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Comparative Example 2 (Production of Optical Member B2)

### [Preparation of Optical Absorption Anisotropic Layer 2]

A laminate 2 was produced by the same procedure as in the laminate 1, except that in the production of the optical absorption anisotropic layer 1, the composition P1 for forming an optical absorption anisotropic layer was changed to the following composition P2 for forming an optical absorption anisotropic layer, and the coating amount was adjusted such that the coating film thickness was 3.2 μm to produce an optical absorption anisotropic layer 2. The laminate 2 had a configuration of the cellulose acylate film 1 with the alignment film/optical absorption anisotropic layer 2/protective layer B1.

Hereinafter, the film comprising the optical absorption anisotropic layer 2 produced above is also referred to as an “optical absorption anisotropic film 2”.

### (Measurement of Transmittance Central Axis of Optical Absorption Anisotropic Layer 2)

The optical absorption anisotropic film 2 was installed on a sample stage in the horizontal direction, and the transmittance was measured while variously changing the azimuthal angle and the polar angle at which the light was incident on the film using AxoScan OPMF-2 (manufactured by Axometrics, Inc.) as described above, and the azimuthal angle and the polar angle of the transmittance central axis of the optical absorption anisotropic layer 2 were examined. The transmittance central axis of the optical absorption anisotropic layer 2 was in a polar angle 0° direction.

Composition P2 for forming optical absorption anisotropic layer

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACURE OXE-02 (manufactured by | 0.20 | parts by mass |
| BASF SE) | | |
| Alignment agent E-1 shown above | 0.16 | parts by mass |
| Alignment agent E-2 shown above | 0.16 | parts by mass |
| Surfactant F-2 shown above: | 0.010 | parts by mass |
| Cyclopentanone | 78.17 | parts by mass |
| Benzyl alcohol | 8.69 | parts by mass |

### [Production of Twist Film 3]

A twist film 3 was produced in the same manner as in the production of the twist film 1, except that in the production of the twist film 1, the coating liquid 1 for a twist layer was changed to the following coating liquid 3 for a twist layer, and the coating amount was adjusted such that the coating film thickness was 2.8 μm. In this case, And of the obtained twist layer was 450 nm. In addition, the twisted angle of the helical liquid crystal compound of the twist layer was 90°.

Coating liquid 3 for twisted layer

| | |
|---|---|
| Methyl ethyl ketone | 233 parts by mass |
| Cyclohexanone | 12 parts by mass |
| Rod-like liquid crystal compound 201 shown above | 83 parts by mass |
| Rod-like liquid crystal compound 202 shown above | 15 parts by mass |
| Rod-like liquid crystal compound 203 shown above | 2 parts by mass |
| Polyfunctional monomer A-TMMT (manufactured by Shin-Nakamura Chemical Co., Ltd.) | 1 part by mass |
| IRGACURE 819 (manufactured by BASF SE) | 4 parts by mass |
| Surfactant 1 shown above | 0.05 parts by mass |
| Surfactant 2 shown above | 0.01 parts by mass |
| Chiral agent 2 shown below | 0.123 parts by mass |

Chiral agent 2

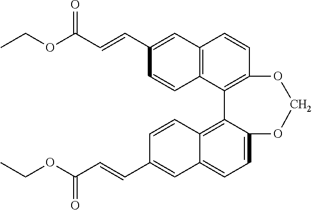

### (Production of Optical Film B2)

The surface of the protective layer B1 formed in the laminate 2 produced in the upper part and the surface of the twist film 3 on which the twist layer was formed were bonded to each other using a commercially available pressure-sensitive adhesive (SK2057, manufactured by Soken Chemical & Engineering Co., Ltd.), and then the peelable support of the twist film 3 was peeled off. Next, the peeled surface and the surface of the protective layer B1 of the laminate 2 prepared separately were bonded to each other using a commercially available pressure-sensitive adhesive (SK2057, manufactured by Soken Chemical & Engineering Co., Ltd.) to produce an optical film B2. The transmittance and the circular polarization degree were measured in the same manner as in Example 1. The results are shown in Table 3.

### [Production of Optical Member B2]

The optical film B2 produced in the upper part and the light guide member produced in the upper part were superimposed on each other to produce an optical member B2. In this case, in a case where the optical member B2 was in a used state, the optical film B2 was disposed such that the slow axis (in-plane slow axis) of the twist layer on the light guide plate side included in the optical film B2 and the horizontal direction were parallel (the angle between the in-plane slow axis and the horizontal direction was 0°).

The layer configuration of the optical member B2 was in the order of “optical absorption anisotropic layer 2/twist film 3/optical absorption anisotropic layer 2/light guide member”. In addition, the optical film B2 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### Comparative Example 3 (Production of Optical Member B3)

### [Production of Polarizing Plate]

A polarizing plate in which a thickness of a polarizer was 8 μm and one surface of the polarizer (the other optical absorption anisotropic layer) was exposed was produced by the same method as that for a polarizing plate 02 with a one-surface protective film, described in WO2015/166991A.

### (Production of Optical Film B3)

The surface of the polarizing plate on which the polarizer was formed and the surface of the λ/4 film on which the λ/4 layer was formed were bonded to each other using a commercially available pressure-sensitive adhesive (SK2057, manufactured by Soken Chemical & Engineering Co., Ltd.), and then the cellulose acylate film (TG40, manufactured by FUJIFILM Corporation) as a support member of the λ/4 layer in the obtained bonded material was peeled off between the cellulose acylate film and the photo-alignment film to produce an optical film B3. In this case, the polarizing plate and the λ/4 film were bonded to each other such that the angle between the absorption axis of the polarizing plate and the slow axis of the λ/4 film was 45°.

The transmittance and the circular polarization degree were measured in the same manner as in Example 1. The results are shown in Table 3.

### [Production of Optical Member B3]

The optical film B3 produced in the upper part and the light guide member produced in the upper part were superimposed on each other to produce an optical member B3. In this case, in a case where the optical member B3 was in a used state, the optical film B3 was disposed such that the absorption axis of the polarizing plate included in the optical film B3 and the horizontal direction were parallel (the angle between the in-plane slow axis and the horizontal direction was 0°).

The layer configuration of the optical member B3 was in the order of “polarizing plate/λ/4 film/light guide member”. In addition, the optical film B3 was disposed on a side of the light guide member opposite to the light guide plate (in other words, a side having the emission diffraction element (liquid crystal diffraction element)) at a position overlapping the emission diffraction element (liquid crystal diffraction element) in the plane direction.

### [Evaluation of Optical Member]

### [Evaluation of Visibility of Field of View]

The optical members of Examples 1 to 6 and Comparative Examples 1 to 3 were evaluated by the following procedure.

The produced optical member was disposed in front of the eyes like a lens of glasses, and the evaluation was performed by viewing in all directions of 360° in the azimuthal direction and in the up-down direction. The evaluation was performed based on the following standard, and the results are shown in Tables 1 to 3.
A: There is no direction in which the state of the room is difficult to see regardless of where the room is viewed.
B: There is a direction in which the room's illumination that hits the diffraction element hits the eyes and the state of the room is slightly difficult to see.
C: There is a direction in which the room's illumination that hits the diffraction element hits the eyes and the state of the room is difficult to see.
D: There is only one direction in which the room's illumination that hits the diffraction element hits the eyes and the state of the room is considerably difficult to see.
E: There are a plurality of directions in which the room's illumination that hits the diffraction element hits the eyes and the state of the room is considerably difficult to see.

In practice, the evaluation of A to D is preferable, the evaluation of C or more is more preferable, the evaluation of B or more is still more preferable, and the evaluation of A is particularly preferable.

### [Evaluation of Brightness in Visual Field]

The optical members of Examples 1 to 6 and Comparative Examples 1 to 3 were evaluated by the following procedure.

The produced optical member was disposed in front of the eyes like a lens of glasses, and the brightness was evaluated. The evaluation was performed based on the following standard, and the results are shown in Tables 1 to 3.
A: The optical member is slightly darker than that in a case where the optical member is not disposed in front of the eyes, but it is not noticeable.
B: The front direction is slightly darker than that in a case where the optical member is not disposed in front of the eyes, but it is not noticeable. However, it is noticeable that it is darker in a case where the line of sight is directed obliquely.
C: The optical member is darker than that in a case where the optical member is not disposed in front of the eyes, and it is noticeable.

In practice, the evaluation of A is preferable.

### Result

The configurations of the optical members of each of Examples and Comparative Examples and the evaluation results are shown in Tables 1, 2, and 3.

The light incident from the normal direction polar angle 60° direction of each optical film (optical films 1 to 6) included in the optical members A1 to A6 is converted into left circularly polarized light.

TABLE 1

| | | | Example 1 | Example 2 | Example 3 | Example 4 |
|---|---|---|---|---|---|---|
| | | | Optical | Optical | Optical | Optical |
| | | | member A1 | member A2 | member A3 | member A4 |
| | | | | | | Optical |
| | | | | Optical | Optical | absorption |
| | | | Optical | absorption | absorption | anisotropic |
| | | | absorption | anisotropic | anisotropic | layer 1 |
| | | | anisotropic | layer 1 | layer 1 | λ/4 film |
| | | | layer 1 | λ/4 film | λ/4 film 2 | C-plate 1 |
| | | | λ/4 film | λ/4 film | λ/4 film 2 | λ/4 film |
| Schematic view of optical member | | | Light guide | Light guide | Light guide | Light guide |
| | | | member | member | member | member |
| Optical absorption | | Transmittance | 0° | 0° | 0° | 0° |
| anisotropic layer | | central axis | | | | |
| Optical | Transmittance (polar | | 73% | 71% | 71% | 68% |
| properties | angle of 0°) | | | | | |
| | Transmittance (polar | | 43% | 41% | 41% | 38% |
| | angle of 30°) | | | | | |
| | Circular | Circular polarization | 93% | 91% | 85% | 91% |
| | polarization | degree in azimuth at | | | | |
| | degree | which circular | | | | |
| | (polar angle | polarization degree | | | | |
| | of 60°) | is maximum | | | | |
| | | Angle width of | Δ40° | Δ100° | Δ120° | Δ120° |
| | | azimuthal angle | | | | |
| | | at which circular | | | | |
| | | polarization degree | | | | |
| | | is 50% or more | | | | |
| Polarization | λ/4 | Re | 140 nm | 140 nm | 140 nm | 140 nm |
| control | | Rth | 80 nm | 80 nm | 125 nm | 80 nm |
| layer | | Slow axis | Angle formed with | Angle between two | Angle between two | Angle between two |
| | | | respect to | slow axes: 45° | slow axes: 45° | slow axes: 45° |
| | | | horizontal | Angle between slow | Angle between slow | Angle between slow |
| | | | direction: 10° | axis of λ/4 film on | axis of λ/4 film on | axis of λ/4 film on |
| | | | | side of optical | side of optical | side of optical |
| | | | | absorption | absorption | absorption |
| | | | | anisotropic | anisotropic | anisotropic |
| | | | | layer and horizontal | layer and horizontal | layer and horizontal |
| | | | | direction: 45° | direction: 45° | direction: 45° |
| | | | | Angle between slow | Angle between slow | Angle between slow |
| | | | | axis of λ/4 film on | axis of λ/4 film on | axis of λ/4 film on |
| | | | | side of light guide | side of light guide | side of light guide |
| | | | | plate and horizontal | plate and horizontal | plate and horizontal |
| | | | | direction: 0° | direction: 0° | direction: 0° |
| | C-plate | Rth | — | — | — | 180 nm |

| Evaluation | Visibility in | D | C | B | B |
|---|---|---|---|---|---|
| | visual field | | | | |
| | Brightness in | A | A | A | A |
| | visual field | | | | |

TABLE 2

| | | | Example 5 | Example 6 |
|---|---|---|---|---|
| | | | Optical member A5 | Optical member A6 |
| Schematic view of optical member | | | Optical absorption | Optical absorption |
| | | | anisotropic layer 1 | anisotropic layer 1 |
| | | | Twist film 1 | Twist film 2 |
| | | | | C-plate 2 |
| | | | Light guide | Light guide |
| | | | member | member |
| Optical absorption anisotropic layer | | Transmittance central axis | 0° | 0° |
| Optical | Transmittance (polar angle of 0°) | | 73% | 70% |
| properties | Transmittance (polar angle of 30°) | | 43% | 40% |
| | Circular | Circular polarization degree | 88% | 90% |
| | polarization degree | in azimuth at which circular | | |
| | (polar angle of 60°) | polarization degree is maximum | | |
| | | Angle width of azimuthal angle | Δ120° | Δ360° |
| | | at which circular polarization | | (omnidirectional) |
| | | degree is 50% or more | | |
| Polarization | Twist layer | Δnd | 550 nm | 500 nm |
| control layer | | Angle between slow axis in vicinity of | 25° | 20° |
| | | interface on side of optical absorption | | |
| | | anisotropic layer 1 and horizontal | | |
| | | direction | | |
| | | Twist angle | 255° | 315° |
| | C-plate | Rth | — | 200 nm |

| | | | |
|---|---|---|---|
| Evaluation | Visibility in visual field | B | A |
| | Brightness in visual field | A | A |

TABLE 3

| | | | Comparative | Comparative | Comparative |
|---|---|---|---|---|---|
| | | | Example 1 | Example 2 | Example 3 |
| | | | Optical | Optical | Optical |
| | | | member B1 | member B2 | member B3 |
| Schematic view of optical member | | | Optical | Optical | Polarizing |
| | | | absorption | absorption | plate |
| | | | anisotropic | anisotropic | |
| | | | layer 1 | layer 2 | |
| | | | | Twist film 3 | λ/4 film |
| | | | | Optical | |
| | | | | absorption | |
| | | | | anisotropic | |
| | | | | layer 2 | |
| | | | Light guide | Light guide | Light guide |
| | | | member | member | member |
| Optical absorption | | Transmittance central axis | 0° | 0° | 0° |
| anisotropic layer | | | | | |
| Optical | Transmittance (polar angle of 0°) | | 74% | 67% | 42% |
| properties | Transmittance (polar angle of 30°) | | 44% | 22% | 40% |
| | Circular | Circular polarization degree | 0% | 92% | 90% |
| | polarization | in azimuth at which circular | | | |
| | degree (polar | polarization degree is | | | |
| | angle of 60°) | maximum | | | |
| | | Angle width of azimuthal | Δ0° | Δ360° | Δ360° |
| | | angle at which circular | | (omnidi- | (omnidi- |
| | | polarization degree is 50% | | rectional) | rectional) |
| | | or more | | | |

| Optical absorption anisotropic layer | | Present | Present | Absent |
|---|---|---|---|---|
| Polarization control layer | | Absent | Twist angle: 90° | Angle between |
| | | | Δnd: 450 nm | slow axis of |
| | | | Angle between slow | λ/4 film and |
| | | | axis in vicinity of | horizontal |
| | | | interface on side of | direction: 45° |
| | | | light guide plate | |
| | | | and horizontal | |
| | | | direction: 0° | |
| Evaluation | Visibility in visual field | E | A | A |
| | Brightness in visual field | A | B | C |

From the results of Tables 1 to 3, it is clear that, with the optical member according to the embodiment of the present invention, in a case of being used in a head-mounted display such as AR glasses in which a background can be visually recognized, the brightness of the background is excellent, and the visibility problem caused by external light incident from above the head of a user using the head-mounted display can be suppressed.

### EXPLANATION OF REFERENCES

10, 40, 60: image display device
12, 48, 62: optical film
14, 42, 64: polarization control layer
16, 46, 66: optical absorption anisotropic layer
22: light guide plate
24: incidence diffraction element
26: emission diffraction element
28: light guide member
30, 50, 68: optical member
32: display element
34: light source
44a: first λ/4 film
44b: second λ/4 film
U: user

What is claimed is:

1. An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
wherein an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more,
the polarization control layer is a λ/4 film, and
in a case where the optical member is arranged in a use configuration, an angle between a slow axis of the λ/4 film and a horizontal direction is 0° to 20°.

2. An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
wherein an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer includes a first λ/4 film and a second λ/4 film, and an angle between a slow axis of the first λ/4 film and a slow axis of the second λ/4 film is 30° to 60°.

3. The optical member according to claim 2,
wherein the polarization control layer includes the first λ/4 film, the second λ/4 film, and a C-plate.

4. An optical member comprising:
an optical film having a polarization control layer and an optical absorption anisotropic layer; and
a light guide plate disposed on a side of the optical film on which the polarization control layer is provided and including a diffraction element in which a diffraction efficiency changes depending on a polarization direction,
wherein an angle between a transmittance central axis of the optical absorption anisotropic layer and a normal direction of the optical absorption anisotropic layer is 0° to 45°,
in the optical film, a circular polarization degree in a direction at an angle of 60° with respect to a normal direction of the optical film at an azimuthal angle in at least one direction is 50% or more, a transmittance in the normal direction of the optical film is 55% or more, and a transmittance in a direction of the optical film at an angle of 30° with respect to the normal direction is 25% or more, and
the polarization control layer is a layer containing a liquid crystal compound having a twisted structure of one or more layers.

5. The optical member according to claim 4,
wherein the polarization control layer includes, in order from a side on which the diffraction element is disposed, the layer containing a liquid crystal compound having a twisted structure of one or more layers and a C-plate.

6. AR glasses comprising:
the optical member according to claim 1.

7. AR glasses comprising:
the optical member according to claim 2.

8. AR glasses comprising:
the optical member according to claim 3.

9. AR glasses comprising:
the optical member according to claim 4.

10. AR glasses comprising:
the optical member according to claim 5.
